(19) United States
(12) Patent Application Publication
(10) Pub. No.: US 2025/0050674 A1
(43) Pub. Date: Feb. 13, 2025

(54) HEAT-SENSITIVE RECORDING MATERIAL IN SHEET FORM

(71) Applicant: Koehler Innovation & Technology GmBH, Oberkirch (DE)

(72) Inventors: Timo STALLING, Appenweier (DE); Kerstin ZIERINGER, Achern (DE)

(21) Appl. No.: 18/720,032

(22) PCT Filed: Dec. 13, 2022
(86) PCT No.: PCT/EP2022/085729

§ 371 Date: Jun. 14, 2024

(30) Foreign Application Priority Data
Dec. 15, 2021 (DE) 10 2021 133 333.4

(51) Int. Cl. B41M 5/44; B41M 5/42

(52) U.S. Cl. CPC B41M 5/443; B41M 5/426; B41M 2205/04; B41M 2205/38; B41M 2205/40

(57) ABSTRACT

The invention relates to a heat-sensitive recording material, comprising: a support material in sheet form, a color layer on one side of the support material in sheet form; and a heat-sensitive layer on the color layer, so that the color layer is at least partially covered, the heat-sensitive layer being such that it becomes translucent by local application of heat, so that the underlying color layer becomes visible; and a protective layer on the heat-sensitive layer, the protective layer containing less than 5% by weight of pigments. The invention also relates to its use as a receipt roll, adhesive label (roll), ticket (roll) or as printer paper for mechanical printers or pens.

The present invention relates to heat-sensitive recording materials and their use as receipt rolls, adhesive labels (rolls), ticket (rolls) or as printer paper for mechanical printers or pens.

Heat-sensitive recording materials are known in principle, wherein a fundamental distinction can be made between two different types of heat-sensitive recording materials, in particular for direct thermal printing:

Type 1: A heat-sensitive recording material in which the printed image is produced by a local, heat-induced chemical reaction in a color layer, e.g., between the color former (e.g., a leuco dye) and the color developer (e.g., bisphenol A or a phenol-free alternative). As a rule, the color layer additionally contains a heat-sensitive solvent that melts under the influence of heat (e.g., long-chain aliphatic alcohols, amides, esters, or carboxylic acids), such that the color reaction of color former and color developer is made possible. Furthermore, the color layer may contain heat-sensitive sensitizers.

Type 2: A heat-sensitive recording material in which the printed image is produced by a heat-sensitive top layer becoming translucent by application of localized heat, e.g., by means of a direct thermal printer, such that an underlying color layer becomes visible. In the prior art, this technology is described or interpreted in different ways, and such a heat-sensitive recording material is obtained using partly different compositions, porosities, and materials of the top layer, is optimized for direct thermal printing, and is explained in more detail below.

In principle, the following applies:
1. The top layer should cover the underlying color layer as well as possible. This is essentially achieved by light scattering (scattering particles) and light absorption.
2. The top layer should have the highest possible contrast to the underlying color layer in order to produce a print image that is legible to the human eye and/or a machine (scanner) (e.g., white/black or blue/yellow).
3. The top layer should be as heat-sensitive as possible such that it becomes translucent when localized heat is applied, in particular by means of conventional direct thermal printers. If possible, it should be possible to use type 1 and type 2 recording materials with a conventional direct thermal printer, and the printer settings should be comparable, in particular the print head temperature and printer speed.

The present invention relates to heat-sensitive recording materials of the type 2 described above.

GB 997289 describes for the first time a recording material for direct thermal printing, comprising a support material, a color layer, and a heat-sensitive cover layer, wherein the heat-sensitive cover layer becomes translucent through the local effect of heat by means of a direct thermal printer, so that the underlying color layer becomes visible and a printed image is produced.

U.S. Pat. No. 6,043,193 describes a heat-sensitive recording material comprising a support and an opaque recording layer applied thereto comprising hollow spherical beads dispersed in a hydrophilic binder, the beads having an average diameter of 0.2 μm to 1.5 μm and a cavity volume of 40% to 90%.

U.S. Pat. No. 6,133,342 describes a heat-sensitive recording material comprising a colorant and an opaque polymeric material whose opacity essentially changes irreversibly, making the colorant more visible when exposed to heat.

WO 2015/119964 A1 discloses an oriented multilayer film for printing, comprising an extruded outer layer, an extruded inner pigment layer, and an extruded image-reproducing layer interposed between the outer layer and the inner pigment layer, wherein the image-reproducing layer comprises a cavity layer having a collapsible layer structure, in which a plurality of cavities are dispersed, wherein the plurality of cavities is formed by orienting the multilayer, wherein the extruded image-reproducing layer and the collapsible layer structure are in a non-collapsed state which is essentially opaque so as to cover the pigment layer thereunder.

US 2010/245524 A describes a heat-sensitive recording material comprising a heat-sensitive substrate having an opaque polymer which is sensitive to the application of heat and pressure and which, when heated to a predetermined temperature and subjected to a predetermined pressure, causes the opaque polymer to become transparent, and a color material disposed with respect to the substrate in such a manner that it is covered by the opaque polymer prior to the application of the predetermined heat and pressure and becomes visible thereafter.

US 2011/172094 A discloses a recording material that comprises the following:
a) a support having a surface impregnated with a colorant or coated with a coating containing a pigment or dye and, disposed thereon,
b) a layer comprising polymer particles including a core-shell structure and, when dry, being hollow to scatter visible light, said particles having an inner first polymer shell with a Tg of 40° C. to 130° C. and an outer second polymer shell with a Tg of −55° C. to 50° C., wherein the Tg of the outer polymer shell is lower than that of the inner polymer shell.

US 2011/251060 A describes a heat-sensitive recording material consisting of a colorant and a flexible carrier substrate, the heat-sensitive recording material further consisting of a heat-sensitive layer, wherein the heat-sensitive layer consists of a binder, a plurality of organic hollow sphere pigments and a thermal solvent, and wherein the heat-sensitive layer is disposed on the colorant. The heat-sensitive layer can be provided with a barrier layer and a protective layer.

WO 2012/145456 A1 describes a heat-sensitive recording material optimized for conventional direct thermal printing, which comprises:
a) a support in the form of a sheet-like structure containing at least one colored surface and disposed thereon,
b) a layer comprising polymer particles having a core-shell structure, wherein said particles have an outer first polymer shell having a calculated Tg of 40° C. to 130° C., wherein said particles, when dry, include at least one cavity, and from 1% by weight to 90% by weight, based on the weight of the polymer particles, of an opacity reducer having a melting point of 45° C. to 200° C.,
wherein the colored surface has a color density sufficient to visibly stick out from the surface of the subsequent layer dispersed thereon, wherein the opacity reducer is an aromatic oxalic acid ester, an aromatic ethylene glycol ether, 1,2-diphenyloxyethane, dibenzyl oxalate, dibenzyl terephthalate, benzylbiphenyl, benzyl 2-naphthyl ether, diphenyl sulfone, m-terphenyl, p-benzyloxybenzyl benzoate, cyclohexanedimethanol benzoate, p-toluenesulfonamide, o-toluenesulfonamide, 2,6-diisopropylnaphthalene, 4,4-diisopropylbiphenyl, erucamide, stearic acid amide, palmitic acid amide or ethylene bis-stearic acid amide.

WO 2013/152287 A1 describes a heat-sensitive recording material with a two-layer, monoaxially oriented film comprising a first layer comprising an opaque beta-nucleated propylene-based polymer and a second layer comprising a dark pigment.

US 2015/049152 A describes a heat-sensitive recording material comprising a heat-sensitive layer disposed on a colored, solid support substrate, wherein the heat-sensitive layer includes single-phase scattering polymer particles each having a center, a surface, a refractive index at the center thereof that is different from a refractive index at the surface thereof, and a continuous refractive index gradient, wherein the heat-sensitive layer further includes heat-deformable particles and a binder.

EP 2993054 A1 describes a web-like heat-sensitive recording material with at least a first layer and a second layer at least partially covering the first layer, wherein the first layer has an intensive coloring at least on the side facing the second layer and the second layer has hollow pigments which can be melted by locally limited heat treatment to form a typeface, which is characterized in that the second layer also contains one or more fatty acids and one or more heat-sensitive sensitizers in addition to the hollow pigments.

In the case of the recording material disclosed in EP 1778499 A1, which basically differs from EP 2993055 A1 only in the type of coloring of the second layer, wherein the typeface becomes visible when exposed to UV radiation instead of becoming visible in the visible range of light, the protective layer can contribute to better printability and to improved environmental resistance, in particular resistance to plasticizers, oils, greases, and moisture, such as sprayed-on water.

EP 2993055 A1 describes a web-like heat-sensitive recording material with at least a first layer and a second layer at least partially covering the first layer, wherein the first layer has an intensive coloring at least on the side facing the second layer and the second layer has hollow pigments which can be melted by locally limited heat treatment to form a typeface, which is characterized in that the recording material has at least one protective layer that at least partially covers the second layer.

According to the wording, a distinction is made in the physical process between two different methods for generating the printed image:
1. The printed image is produced by making a heat-sensitive top layer translucent through the local effect of heat by means of a direct thermal printer, wherein the top layer comprises fusible hollow pigments.
2. The printed image is produced by making a heat-sensitive top layer translucent through the local effect of heat by means of a direct thermal printer, wherein the top layer comprises softenable or dissolvable hollow pigments.

In accordance with this specification, an acceptable gray recording material with the following key figures can be obtained: Whiteness of 56% or 52% with or without UV component, optical density (unprinted) of 0.33 ODU, optical density (printed) of 1.22 ODU and contrast of 0.89 ODU (thermal head 300 dpi, 16 mJ/mm²).

The associated divisional application EP 3517309 A1 particularly specifies the feature of the covering layer which comprises hollow body pigments, which can be manipulated to form a typeface, and at least one fatty acid, namely stearic acid and/or palmitic acid or stearic acid amide, and/or methyl stearic acid amide.

US 2017/337851 A discloses a recording material, comprising:
a release liner base stock layer,
an optional adhesive layer,
a label base stock layer,
a thermal insulation layer disposed over the label base stock layer,
an ink layer disposed over the thermal insulation layer, wherein the ink layer comprises at least one color,
a covering layer disposed over the printed ink layer, and
a top coat layer disposed over the top layer,
wherein the covering layer comprises an acrylic-based composition containing light-scattering particles that cause the covering layer to be opaque in a first state and transparent in a second state, wherein at least heat or pressure is applied from a print head that causes the top layer to transition from the first state to the second state, thereby enabling the at least one color of the ink layer to be visible through the covering layer.

WO 2019/183471 A1 discloses a recording medium comprising a substrate, wherein the substrate is involved in first scattering particles with a melting point that comprise a first solid light scattering layer, and the first light scattering layer is as close as possible to a plurality of second solid scattering particles, wherein the second solid scattering particles have a lower melting point than the first melting point of the second solid scattering particles, and wherein the first light scattering layer is porous and the second scattering particles are described upon melting of the solid, wherein the first solid scattering particles are disposed to fill the space between the recording medium.

WO 2019/219391 A1 describes a heat-sensitive recording material comprising a carrier substrate which is black or colored on at least one side and a thermoresponsive layer on the at least one black or colored side of the carrier substrate, wherein the thermoresponsive layer comprises nanoparticles of at least one cellulose ester.

WO 2021/055719 A1 describes a heat-or pressure-sensitive recording material comprising a layer of an opaque material, a color material disposed on a first side of the layer of opaque material, the layer of opaque material covering the color material, wherein the opaque material in an opaque state comprises a plurality of irregular and/or uneven shaped opaque polymer particles defining cavities therebetween, and having different shapes and/or different sizes, and further wherein the opaque material is configured to change from the opaque state to a transparent state upon application of sufficient temperature and/or pressure to expose the coloring material beneath the opaque material.

WO 2021/062230 A1 discloses a recording medium comprising a substrate, a first light scattering layer supported by the substrate and containing first scattering particles having a first melting point, and
a plurality of second scattering particles in proximity to the first light scattering layer, wherein the second scattering particles have a second melting point that is lower than the first melting point, wherein the first light scattering layer is porous, and the second scattering particles are disposed to fill spaces between the first scattering particles upon melting, and wherein the first scattering particles comprise perforated particles.

All of these known heat-sensitive recording materials are in need of improvement, particularly with regard to their functionality, sustainability, and economic production. In particular, it is desirable to maintain or further increase the protection of heat-sensitive recording materials against external influences such as pressure, friction, moisture, liquids, and wetness. Further, the functionality, properties and economic manufacturability of the heat-sensitive recording materials are to be maintained or improved, in particular with regard to the sensitivity, water abrasion resistance and deposition behavior of heat-sensitive recording materials on the thermal print head of thermal printers, with as few or no depositions as possible that could negatively affect the long-term operation of the thermal printer (more than 10 km throughput).

The present invention addresses this need.

Surprisingly, these problems were solved by a heat-sensitive recording material according to claim 1, i.e. by a heat-sensitive recording material comprising a support material in sheet form, a color layer on one side of the support material in sheet form and a heat-sensitive layer on the color layer so that the color layer is at least partially covered, the heat-sensitive layer being designed such that it becomes translucent by local application of heat, so that the underlying color layer becomes visible, a protective layer on the heat-sensitive layer, which is characterized in that the protective layer contains less than 5% by weight of pigments.

Such heat-sensitive recording materials are significantly improved, particularly in terms of their functionality, their environmental properties (sustainability), and/or their economic production (simple and cost-effective). Further, such heat-sensitive recording materials have advantageous properties in terms of protecting the heat-sensitive recording materials from external influences such as pressure, friction, moisture, liquids, and wetness. Additionally, such heat-sensitive recording materials are improved in terms of sensitivity, water-wet abrasion resistance and deposition behavior on the thermal print head of thermal printers.

Numerous specific details are also discussed below in order to provide a comprehensive understanding of the present subject matter. However, it is obvious to the person skilled in the art that the subject matter can also be practiced and reproduced without these specific details.

All features of one embodiment can be combined with features of another embodiment if the features of the different embodiments are not incompatible.

It is also understood that although the terms “first”, “second”, etc. may be used herein to describe various elements, these elements are not intended to be limited by these terms. These terms are only used to distinguish one element from another. For example, a first object or first step could be referred to as a second object or second step, and similarly, a second object or second step could be referred to as a first object or first step. The first object or the first step and the second object or the second step are both objects or steps, but they are not to be regarded as the same object or the same step.

The terminology used in the description of the present disclosure is intended only to describe certain embodiments and should not be construed as limiting the subject matter. As used in the present description and claims, the singular forms “a”, “an” are to be understood to include the plural forms as well, unless the context clearly dictates otherwise. This also applies vice versa, i.e., the plural forms also include the singular forms. It is also understood that the term “and/or” as used herein refers to and includes all possible combinations of one or more of the associated listed elements. Moreover, it is to be understood that the terms “include”, “including”, “comprise”, and/or “comprising”, when used in the present description and claims, specify the presence of the specified features, steps, operations, elements, and/or components, but do not exclude the presence or addition of one or more other features, steps, operations, elements, components, and/or groups thereof.

In the present description and claims, the terms “include”, “comprise”, and/or “comprising” may also mean “consisting of”, i.e., the presence or addition of one or more other features, steps, operations, elements, components, and/or groups is excluded.

In the present description and claims, the term “including” can therefore also mean “exclusively”.

In this description, the Bekk smoothnesses mentioned are determined according to DIN 53107 (2016).

The invention relates to a heat-sensitive recording material comprising a support material in sheet form, a color layer on one side of the support material in sheet form and a heat-sensitive layer on the color layer so that the color layer is at least partially covered, the heat-sensitive layer being designed such that it becomes translucent by local application of heat, so that the underlying color layer becomes visible, a protective layer on the heat-sensitive layer, which is characterized in that the protective layer contains less than 5% by weight of pigments.

It is advantageous to provide a smooth support material in sheet form and to maintain this smoothness over the individual coatings. The smoother the substrate is built up from below, the better is the final smoothness, and therefore the sensitivity of the end product.

Preferably, the support material has a Bekk smoothness of more than 30 s, particularly preferably more than 50 s on the side to which the color layer is applied.

The color layer preferably has a Bekk smoothness of more than 50 s, particularly preferably more than 100 s, and most particularly preferably more than 150 s on the side to which the heat-sensitive layer is applied.

The heat-sensitive layer preferably has a Bekk smoothness of more than 100 s, particularly preferably more than 250 s, on the side on which the color layer is not located.

Preferably, the support material has a Bekk smoothness of 20 to 400 s, particularly preferably of 30 to 300 s, and most particularly preferably of 50 to 200 s on the side to which the color layer is applied. Most preferably, the Bekk smoothness is 50 to 150 s.

The color layer preferably has a Bekk smoothness of 50 to 400 s, particularly preferably of 100 to 250 s, and most particularly preferably of 150 to 250 s on the side to which the heat-sensitive layer is applied.

The heat-sensitive layer preferably has a Bekk smoothness of 100 to 1000 s, particularly preferably of 250 to 800 s, on the side on which the color layer is not located.

It is preferred that each layer applied to the support material in sheet form has a Bekk smoothness on its upper side, i.e., on the side not facing the support material in sheet form, which is at least as great or greater than that of the respective layer below.

Preferably, each layer applied to the support material in sheet form has a Bekk smoothness of at least 5% (percentage increase) on its upper side, i.e., on the side not facing the support material in sheet form, compared to the respective layer below.

Preferably, each layer applied to the web-like carrier material has a Bekk smoothness of at least 5 s (absolute increase) on its upper side, i.e., on the side not facing the web-like carrier material, compared to the respective layer below.

The support material in sheet form is not limited in principle. In a preferred embodiment, the support material in sheet form comprises paper, synthetic paper, and/or a plastic film. The support material preferably has a basis weight of 30 to 100 g/m², in particular 40 to 80 g/m².

The support material in sheet form of the heat-sensitive recording material according to the invention comprises at least one color layer, i.e., at least one black or colored side, which is achieved by applying the color layer. The term “colored side” means that the side has a color other than white or black. In other words, the heat-sensitive recording material comprises at least one side that is colored such that it is not white. Additionally, embodiments are possible in which the at least one black or colored side has several different colors, also in combination with the color black.

The at least one color layer on one side of the support material in sheet form is preferably characterized in that the color layer comprises at least one pigment and/or a dye, and preferably a binder.

The pigments and/or dyes comprise various organic and inorganic pigments, dyes, and/or carbon black. These can be used alone or in any mixture.

The pigment, the dye and/or the carbon black are preferably contained in the color layer in an amount of 2 to 50% by weight, particularly preferably 10 to 35% by weight, based on the total solids content of the color layer.

Carbon black is generally understood to be a black, powdery solid which, depending on quality and use, consists of 80% to 99.5% of carbon and can be obtained, for example, by the incomplete combustion and/or thermal decomposition of hydrocarbons.

As binders, water-soluble starches, starch derivatives, starch-based biolatices of the EcoSphere type, methyl cellulose, hydroxyethyl cellulose, carboxymethyl cellulose, gelatine, casein, partially or completely saponified polyvinyl alcohols, chemically modified polyvinyl alcohols, ethylene-vinyl alcohol copolymers, sodium polyacrylates, styrene-maleic anhydride copolymers, ethylene-maleic anhydride copolymers, styrene-butadiene copolymers, acrylamide (meth)acrylate copolymers, acrylamide-acrylate-methacrylate terpolymers, polyacrylates, poly (meth)acrylic acid esters, acrylate-butadiene copolymers, polyvinyl acetates, and/or acrylonitrile-butadiene copolymers are used preferably. These can be used alone or in any mixture.

The binder is preferably contained in the color layer in an amount of 2 to 40, particularly preferably 10 to 30, based on the total solids content of the color layer.

The color layer preferably has a basis weight of 1 to 10 g/m², in particular 3 to 8 g/m².

The color layer preferably has a thickness of 1 to 10 μm, in particular 2 to 8 μm.

In another preferred embodiment, the heat-sensitive recording material is characterized in that the heat-sensitive layer comprises at least one scattering particle, in particular a polymer particle, having a glass transition temperature of −55 to 130° C., preferably of 40 to 80° C.

In another preferred embodiment, the heat-sensitive recording material is characterized in that the heat-sensitive layer comprises at least one scattering particle, more particularly a polymer particle, having a core/shell structure, wherein the scattering particles, more particularly the polymer particles, are selected from the group consisting of (i) scattering particles, more particularly polymer particles having an outer shell with a glass transition temperature of 40° C. to 80° C., and (ii) scattering particles, more particularly polymer particles, having an inner shell with a glass transition temperature of 40° C. to 130° C., and an outer shell with a glass transition temperature of −55° C. to 50° C., the glass transition temperature of the outer shell preferably being lower than that of the inner shell.

In another preferred embodiment, the heat-sensitive recording material is characterized in that the heat-sensitive layer at least one scattering particle, more particularly a polymer particle, having a melting temperature below 250° C., preferably from 0° C. to 250° C.

In another preferred embodiment, the heat-sensitive recording material is characterized in that the heat-sensitive layer comprises at least one scattering particle, more particularly a polymer particle, with an average particle size in the range from 0.1 to 2.5 μm, preferably from 0.2 to 0.8 μm.

In another preferred embodiment, the heat-sensitive recording material is characterized in that the heat-sensitive layer comprises at least one scattering particle, more particularly a polymer particle, having a glass transition temperature of −55 to 130° C., preferably of 40 to 80° C., and having an average particle size in the range from 0.1 to 2.5 μm, preferably from 0.2 to 0.8 μm.

In another preferred embodiment, the heat-sensitive recording material is characterized in that the heat-sensitive layer comprises at least one scattering particle, more particularly a polymer particle, having a core/shell structure, wherein the scattering particles, more particularly the polymer particles, are selected from the group consisting of (i) scattering particles, more particularly polymer particles having an outer shell with a glass transition temperature of 40° C. to 80° C., and (ii) scattering particles, more particularly polymer particles, having an inner shell with a glass transition temperature of 40° C. to 130° C., and an outer shell with a glass transition temperature of −55° C. to 50° C., the glass transition temperature of the outer shell preferably being lower than that of the inner shell, and having an average particle size in the range of 0.1 to 2.5 μm, preferably from 0.2 to 0.8 μm.

In another preferred embodiment, the heat-sensitive recording material is characterized in that the heat-sensitive layer comprises at least one scattering particle, more particularly a polymer particle having a melting temperature below 250° C., preferably from 0° C. to 250° C., and having an average particle size in the range from 0.1 to 2.5 μm, preferably from 0.2 to 0.8 μm.

A glass transition temperature or a melting temperature of less than 250° C. was found to be advantageous. Above temperatures of 250° C., direct thermal printing is not possible, since the temperature-time window is outside the printer specification.

An average particle size in the range of 0.1 to 2.5 μm is advantageous, since particles of this size scatter the visible light and thus cover the color layer as much as possible.

The average particle size can be determined using a Beckman Coulter instrument (laser diffraction, Fraunhofer method).

The scattering particles, in particular the polymer particles, are preferably crystalline, semi-crystalline, and/or amorphous.

The glass transition temperatures mentioned above refer to semi-crystalline or amorphous scattering particles, in particular polymer particles. The melting temperatures refer to crystalline scattering particles, in particular polymer particles, or to the crystalline portion of the scattering particles, in particular the polymer particles, respectively.

The primary property of the scattering particles, preferably the polymer particles, is light scattering in the visible range of light. The secondary property is heat sensitivity.

The polymer particles preferably comprise thermoplastic polymers.

The polymer particles preferably comprise polymers, selected from the polymerization of one or more monomers, selected from the group comprising acrylnitrile, styrene, butadiene, benzyl methacrylate, phenyl methacrylate, ethyl methacrylate, divinyl benzene, 2-hydroxyethyl methacrylate, cyclohexyl methacrylate, 2-methylstyrene, 3-methylstyrene, 4-methylstyrene, alpha-methylstyrene, beta-methylstyrene, acrylamide, methacrylamide, methacrylonitrile, hydroxypropyl methacrylate, methoxystyrene, N-acrylyl glycinamide, and/or N-methacrylyl glycinamide, and/or derivatives thereof.

In another embodiment, the polymer particles may be polymerized using a plurality of ethylenically unsaturated monomers. Examples of nonionic monoethylenically unsaturated monomers comprise styrene, vinyl toluene, ethylene, vinyl acetate, vinyl chloride, vinylidene chloride, acrylonitrile, (meth)acrylamide, various (C₁-C₂₀)-alkyl- or (C₃-C₂₀)-alkenyl esters of (meth)acrylic acid, including methyl acrylate (MA), methyl methacrylate (MMA), ethyl (meth)acrylate, butyl (meth)acrylate, 2-hydroxyethyl (meth)acrylate, 2-ethylhexyl (meth)acrylate, benzyl (meth)acrylate, lauryl (meth)acrylate, oleyl (meth)acrylate, palmityl (meth)acrylate, and stearyl (meth)acrylate. Typically, acrylic esters such as MMA, EA, BA, and styrene are preferred monomers for polymerization and formation of the shell of the polymer particles. Difunctional vinyl monomers such as divinylbenzene, allyl methacrylate, ethylene glycol dimethacrylate, 1,3-butanediol dimethacrylate, diethylene glycol dimethacrylate, trimethylolpropane trimethacrylate, and the like can also be copolymerized to form a crosslinked outer shell as described in US patent application 2003-0176535 A1.

In another embodiment, the polymer particles preferably comprise (meth)acrylonitrile copolymers, polyvinyl chloride, polyvinylidene chloride, polystyrene, styrene acrylate, styrene-(meth)acrylate copolymers, polyacrylonitrile, polyacrylic acid esters, or also mixtures of at least two of these.

The strength and durability of the polymer particles can be influenced by crosslinking of polymer chains.

The scattering particles, in particular the polymer particles, can be in the form of closed polymer particles, open polymer particles, and/or solid particles, each of which can be regularly or irregularly shaped.

Examples of closed hollow particles include hollow spherical polymer particles or polymer particles with a core/shell structure.

Examples of hollow spherical polymer particles or polymer particles with a core/shell structure are Ropaque HP-1055, Ropaque OP-96, and Ropaque TH-1000.

Examples of polymer particles may include, in particular, so-called “cup-shaped” polymer particles. These particles have the same materials, as to the shell, as the closed polymer particles, in particular the closed hollow spherical polymer particles. In contrast to the classic hollow pigments, in which an inner core of gas, usually air, is completely enclosed by a shell of organic, usually thermoplastic components, the “cup-shaped” polymer particles do not have a closed shell and only surround the inner core in the form of a bowl or cup that is as closed as possible.

Further examples of open polymer particles may include cage-like polymer particles as described in WO 2021/062230 A1.

Examples of solid particles may include polyethylene, polystyrene, and cellulose esters.

The above-mentioned scattering particles, in particular the polymer particles, can be shaped regularly or irregularly.

In an alternative embodiment, the polymer particles are spherical solid particles, preferably shaped irregularly, and/or spherical hollow particles, both preferably in the form of droplets. These preferably include polystyrene, e.g., Plastic Pigment 756A from Trinseo LLC., and Plastic Pigment 772HS from Trinseo LLC., polyethylene, e.g., Chemipearl 10 W401 from Mitsui Chemical Inc., spherical hollow particles (HSP)/spherical hollow pigments, e.g., Ropaque TH-500EF from The Dow Chemical Co., modified polystyrene particles, e.g., Joncryl 633 from BASF Corp., 1,2-diphenoxyethane (DPE), ethylene glycol m-tolyl ether (EGTE), and/or diphenyl sulfone (DPS). These can be used alone or in any mixture. These polymer particles preferably have an average particle size of 0.2 μm, 0.3 μm, 0.4 μm, 0.45 μm, 0.75 μm, or 1.0 μm.

The scattering particles, in particular a polymer particle, are preferably contained in the heat-sensitive layer in an amount of 20% by weight to 60% by weight, preferably 30% by weight to 50% by weight, based on the solids content of the heat-sensitive layer.

Preferably, the heat-sensitive layer comprises at least one heat-sensitive material with a melting temperature in the range from 40 to 200° C., preferably from 80 to 140° C., and/or a glass transition temperature in the range from 40 to 200° C., preferably from 80 to 140° C.

Preferably, the heat-sensitive layer comprises at least one heat-sensitive material with an average particle size of 0.2 to 4.0 μm, preferably 0.5 to 2.0 μm.

Additionally, the heat-sensitive material preferably contributes to the opacity (covering power) of the heat-sensitive layer, e.g., by absorbing and/or scattering light. It is assumed that the heat-sensitive material quickly melts locally when exposed to localized heat from the thermal print head of the direct thermal printer, resulting in a local “softening” of the polymer particles, and thus a local reduction in opacity (opacity reduction), such that the top layer becomes translucent and the underlying color layer becomes visible.

The heat-sensitive material can also be referred to as a sensitizing agent or thermal solvent.

Preferably, the heat-sensitive material comprises one or more fatty acids, such as stearic acid, behenic acid or palmitic acid, one or more fatty acid amides, such as stearamide, behenamide or palmitamide, an ethylene bis-fatty acid amide, such as N,N′-ethylene bis (stearic acid amide) or N,N′-ethylene bis (oleic acid amide), one or more fatty acid alkanolamides, more particularly hydroxymethylated fatty acid amides, such as N-(hydroxymethyl) stearamide, N-hydroxymethyl palmitamide, hydroxyethyl stearamide, one or more waxes, such as polyethylene wax, candelilla wax, carnauba wax, or montan wax, one or more carboxylic acid esters, such as dimethyl terephthalate, dibenzyl terephthalate, benzyl 4-benzyloxybenzoate, di-(4-methylbenzyl) oxalate, di-(4-chlorobenzyl) oxalate or di-(4-benzyl) oxalate, ketones, such as 4-acetyl biphenyl, one or more aromatic ethers, such as 1,2-diphenoxyethane, 1,2-di-(3-methylphenoxy) ethane, 2-benzyloxynaphthalene, 1,2-bis (phenoxymethyl) benzene, or 1,4-diethoxynaphthalene, one or more aromatic sulfones, such as diphenyl sulfone, and/or an aromatic sulfonamide, such as 2-, 3-, 4-toluenesulfonamide, benzene sulfonanilide, or N-benzyl-4-toluenesulfonamide, or one or more aromatic hydrocarbons, such as 4-benzyl biphenyl, or combinations of the above compounds. These can be used alone or in any mixture.

Stearamide is preferred as it has an advantageous cost-performance ratio.

The heat-sensitive material is preferably present in the heat-sensitive layer in an amount of about 10 to about 80% by weight, particularly preferably in an amount of about 25 to about 60% by weight, based on the total solids content of the heat-sensitive layer.

Optionally, lubricants or release agents can be present in the heat-sensitive layer.

These agents preferably are fatty acid metal salts, such as, e.g., zinc stearate or calcium stearate, or even behenate salts, synthetic waxes, e.g., in the form of fatty acid amides such as, e.g., stearic acid amid and behenic acid amide, fatty acid alkanolamides such as, e.g., stearic acid methylolamide, paraffin waxes of different melting points, ester waxes of different molecular weights, ethylene waxes, propylene waxes of different hardnesses, and/or natural waxes, such as, e.g., carnauba wax or montan wax. These can be used alone or in any mixture.

Zinc stearate is preferred, since it has an advantageous cost-performance ratio.

The lubricant or release agent is preferably present in the heat-sensitive layer in an amount of about 1 to about 10% by weight, particularly preferably in an amount of about 3 to about 6% by weight, based on the total solids content of the heat-sensitive layer.

In another preferred embodiment, at least one binder (binding agent) is present in the heat-sensitive layer. These preferably are water-soluble starches, starch derivatives, starch-based biolatices of the EcoSphere type, methyl cellulose, hydroxyethyl cellulose, carboxymethyl cellulose, gelatine, casein, partially or completely saponified polyvinyl alcohols, chemically modified polyvinyl alcohols, ethylene-vinyl alcohol copolymers, sodium polyacrylates, styrene-maleic anhydride copolymers, ethylene-maleic anhydride copolymers, styrene-butadiene copolymers, acrylamide (meth)acrylate copolymers, acrylamide-acrylate-methacrylate terpolymers, polyacrylates, poly(meth)acrylic acid esters, acrylate-butadiene copolymers, polyvinyl acetates, and/or acrylonitrile-butadiene copolymers are used preferably. These can be used alone or in any mixture.

Partially saponified polyvinyl alcohols, preferably with a degree of saponification between 85 and 99%, in particular about 88%, are particularly preferred, since they have an advantageous price-performance ratio.

The binder is preferably present in the heat-sensitive layer in an amount of 1 to 30% by weight, preferably 5 to 20% by weight, based on the total solids content of the heat-sensitive layer.

In order to achieve specific application-related performance characteristics of heat-sensitive recording materials, the binder is preferably present in crosslinked form in the heat-sensitive layer, wherein the optimum degree of crosslinking of the binder is achieved in the drying step of the coating process in the presence of a crosslinking agent (crosslinker).

The crosslinking agents may be polyvalent aldehydes such as glyoxal, dialdehyde starch, glutaraldehyde, optionally in a mixture with boron salts (borax), salts or esters of glyoxylic acid, crosslinkers based on ammonium zirconium carbonate, polyamidoamine-epichlorohydrin resins (PAE resins), adipic acid dihydrazide (AHD), boric acid or its salts, polyamines, epoxy resins, formaldehyde oligomers, cyclic ureas, methylol urea, melamine formaldehyde oligomers, etc. These can be used alone or in any mixture.

Ammonium zirconium carbonate and polyamidoamine-epichlorohydrin resins (PAE resins) are particularly preferred for reasons of food conformity.

Self-crosslinking binders, such as specially modified polyvinyl alcohols or acrylates, enable crosslinking without any crosslinking agents due to the reactive, crosslinkable groups that are already incorporated in the binder polymer.

The crosslinker is preferably present in an amount of about 0.01 to about 25.0% by weight, particularly preferably in an amount of about 0.05 to about 15.0% by weight, based on the total solids content of the color layer.

In another preferred embodiment, the heat-sensitive layer contains pigments. These pigments may be the same or different from the pigments in the color layer. One of the advantages of using these pigments is that they can fix the molten chemicals produced in the thermal printing process to their surface. Pigments can also be used to control the surface whiteness and opacity of the heat-sensitive layer and its printability with conventional printing inks.

Particularly suitable pigments are inorganic pigments, both of synthetic and natural origin, preferably clays, precipitated or natural calcium carbonates, aluminum oxides, aluminum hydroxides, silicas, precipitated and fumed silicas (e.g., Aerodisp types), diatomaceous earths, magnesium carbonates, talc, kaolin, titanium oxide, bentonite, but also organic pigments such as hollow pigments with a styrene/acrylic copolymer wall or urea/formaldehyde condensation polymers. These can be used alone or in any mixture.

Preferred are calcium carbonates, aluminum hydroxides, fumed silicas, as they enable particularly advantageous application properties of the heat-sensitive recording materials regarding their subsequent printability with commercially available printing inks.

The pigments are preferably present in the heat-sensitive layer in an amount of about 2 to about 50% by weight, particularly preferably in an amount of about 5 to about 20% by weight, based on the total solids content of the heat-sensitive layer.

The heat-sensitive layer may also contain carbon black components and/or dyes/color pigments.

To control the surface whiteness of the heat-sensitive recording material according to the invention, optical brighteners can be incorporated into the heat-sensitive color-forming layer. These are preferably stilbenes.

The heat-sensitive layer may also contain inorganic oil-absorbing white pigments.

Examples of these inorganic oil-absorbing white pigments include natural or calcined kaolin, silica, bentonite, calcium carbonate, aluminum hydroxide, in particular boehmite, and mixtures thereof.

The inorganic oil-absorbing white pigments are preferably present in the heat-sensitive layer in an amount of about 2 to about 50% by weight, particularly preferably in an amount of about 5 to about 20% by weight, based on the total solids content of the heat-sensitive layer. In order to improve certain coating properties, it is preferable in individual cases to add additional components, in particular rheology additives such as, e.g., thickeners and/or surfactants, to the components of the heat-sensitive recording material according to the invention.

The additional components are preferably present in the usual quantities known to those skilled in the art.

The heat-sensitive layer preferably has a basis weight of 1 to 8 g/m², in particular 2 to 6 g/m².

The heat-sensitive layer preferably has a thickness of 1 to 10 μm, in particular 2 to 8 μm.

In another preferred embodiment, the heat-sensitive recording material is preferably characterized in that an insulating layer is present between the support material in sheet form and the color layer.

In an alternative embodiment, the heat-sensitive recording material is preferably characterized in that the color layer is both a color layer and an insulating layer.

Such an insulating layer, or a color layer that is both a color layer and an insulating layer, causes a reduction of heat conduction through the heat-sensitive recording material. This makes the application of localized heat using a direct thermal printer more efficient and enables a higher thermal printer speed. The top layer becomes translucent more quickly due to the amount of heat applied, thus improving sensitivity.

This means that less dye is required, which results in improved recyclability in the material cycle, in particular in the waste paper cycle (easier deinkability, separation of dye and support material components).

The insulating layer or the color layer, which is both a color layer and an insulating layer, preferably has a Bekk smoothness of more than 50 s, particularly preferably of more than 100 s, and most particularly preferably of 100 to 250 s.

The insulating layer or the color layer, which is both a color layer and an insulating layer, preferably comprises a heat-insulating material.

Preferably, the heat-sensitive recording material with an insulating layer or a color layer, which is also an insulating layer, has a lower thermal conductivity than a heat-sensitive recording material that does not comprise an insulating layer or a color layer that is also an insulating layer.

The heat-insulating material preferably comprises kaolin, particularly preferably calcined kaolin and mixtures thereof.

The heat-insulating material may also comprise hollow sphere pigments, in particular hollow sphere pigments a comprising styrene-acrylate copolymer.

These hollow sphere pigments preferably have a glass transition temperature of 40 to 80° C. and/or an average particle size of 0.1 to 2.5 μm.

The heat-insulating material is preferably present in the insulating layer in an amount of about 20 to about 80% by weight, particularly preferably in an amount of about 40 to about 60% by weight, based on the total solids content of the insulating layer.

In a color layer, which is both a color layer and an insulating layer, the heat-insulating material is preferably present in an amount of about 30 to about 70% by weight, particularly preferably in an amount of about 40 to about 60% by weight, based on the total solids content of the color layer, which is both a color layer and an insulating layer.

In another embodiment, the heat-sensitive recording material is characterized in that the insulating layer or the color layer, which is both a color layer and an insulating layer, comprises a mixture of scattering particles, in particular polymer particles, preferably comprising a styrene-acrylate copolymer, and at least one inorganic pigment, in particular calcined kaolin.

It has been shown that using any mixture of scattering particles/polymer particles (e.g., styrene-acrylate copolymer) and inorganic pigment (e.g., calcined kaolin) in the insulating/color layer offers particular advantages in terms of improved barcode readability of the heat-sensitive recording material due to a high degree of fixation of the heat-sensitive layer on the color layer.

The mixing ratio between scattering particles/polymer particles and inorganic pigment is preferably in the range from 8:1 to 1:8, particularly preferably in the range from 4:1 to 1:4, based on the quantities [% by wt.] in the oven-dry state (ods).

The term “scattering particles” is to be understood analogously to the above definition.

In order to achieve specific application-related performance characteristics of heat-sensitive recording materials, the binder is preferably present in a crosslinked form in the insulating layer and/or color layer, wherein the optimum degree of crosslinking of the binder is achieved in the drying step of the coating process in the presence of a crosslinking agent (crosslinker).

The crosslinking agents may be polyvalent aldehydes such as glyoxal, dialdehyde starch, glutaraldehyde, optionally in a mixture with boron salts (borax), salts or esters of glyoxylic acid, crosslinkers based on ammonium zirconium carbonate, polyamidoamine-epichlorohydrin resins (PAE resins), adipic acid dihydrazide (AHD), boric acid or its salts, polyamines, epoxy resins, formaldehyde oligomers, cyclic ureas, methylol urea, melamine formaldehyde oligomers, etc. These can be used alone or in any mixture.

Ammonium zirconium carbonate and polyamidoamine-epichlorohydrin resins (PAE resins) are particularly preferred for reasons of food conformity.

Self-crosslinking binders, such as specially modified polyvinyl alcohols or acrylates, enable crosslinking without any crosslinking agents due to the reactive, crosslinkable groups that are already incorporated in the binder polymer.

The crosslinker is preferably present in an amount of about 0.01 to about 25.0% by weight, particularly preferably in an amount of about 0.05 to about 15.0% by weight, based on the total solids content of the insulating or the color layer, respectively.

The insulating layer preferably has a basis weight of 1 to 5 g/m², in particular 2 to 4 g/m².

The insulating layer preferably has a thickness of 1 to 10 μm, in particular 2 to 8 μm.

The color layer, which is both a color layer and an insulating layer, preferably has a basis weight of 1 to 10 g/m², in particular 3 to 8 g/m².

The color layer, which is both a color layer and an insulating layer, preferably has a thickness of 1 to 12 μm, in particular 4 to 8 μm.

In another preferred embodiment, the heat-sensitive recording material is preferably characterized in that a layer comprising starch (starch precoat) and/or modifications thereof (modified starches) is present directly on at least one side of the support material in sheet form, preferably directly on both sides of the support material in sheet form.

The starch precoat is preferably applied in an amount of 0.1 to 3, particularly preferably 0.2 to 1.5 g/m².

A starch precoat on the side of the support material in sheet form on which the color layer is present has the advantage that the support material in sheet form is sealed, thus improving the adhesion of the color layer and reducing or preventing penetration of the color layer into the support material in sheet form.

A starch precoat on the side of the support material in sheet form on which the color layer is not present has the advantage that a strike through of the color layer through the support material in sheet form can be reduced or prevented.

The layer comprising starch preferably has a Bekk smoothness of more than 20 s, more preferably of more than 50 s, and most preferably of 50 to 200 s.

According to the invention, the heat-sensitive recording material is preferably characterized in that a protective layer is present on the heat-sensitive layer.

This protective layer is on the side of the heat-sensitive layer facing away from the color layer.

The protective layer preferably has a Bekk smoothness of at least 350 s, preferably of 500 s, more preferably of at least 750 s, and particularly preferably of at least 1000 s.

The protective layer preferably has a Bekk smoothness of at least 350 s, preferably of at least 750 s, and particularly preferably of at least 1000 s, wherein the Bekk smoothness is determined according to DIN 53107 (2016), so that the thermosensitive recording material has a dynamic color density (dynamic sensitivity) of at least 1.35, preferably of 1.38-2%, optical density units (corresponds to OD 1 (12.79 mJ/mm²)) according to the method for determining the dynamic color density (determination of the dynamic sensitivity) defined in the description.

Without being bound by this theory, the inventors have noticed that an increase in Bekk smoothness leads to an increase in dynamic color density (dynamic sensitivity).

Preferably, the Bekk smoothness of the protective layer is not higher than 2000 s, preferably not higher than 1600 s.

The protective layer may contain at least one pigment.

In another embodiment, the protective layer contains no pigment(s).

If at least one pigment is present in the protective layer, this at least one pigment is present in the protective layer in an amount of less than 5% by weight (more than 0 to less than 5% by weight), based on the solids content of the protective layer.

In a preferred embodiment, the protective layer contains the at least one pigment in an amount of less than 4% by weight (more than 0 to less than less than 4% by weight) or less than 3% by weight (more than 0 to less than 3% by weight) or less than 2% by weight (more than 0 to less than 2% by weight) or less than 1% by weight (more than 0 to less than 1% by weight by weight) or less than 0.5% by weight (more than 0 to less than 0.5% by weight) or less than 0.2% by weight (more than 0 to less than 0.2% by weight) or less than 0.1% by weight (more than 0 to less than 0.1% by weight) or less than 0.01% by weight (more than 0 to less than 0.01% by weight) or no pigments at all except for unavoidable impurities or unavoidable traces, or no pigments at all. These quantities refer to the solids content of the protective layer.

Unavoidable impurities or unavoidable traces of pigments can end up in the protective layer, e.g. due to the production process, if pigments (pigment-containing coating colors) have been or are being processed in the production plant, e.g. when applying previously applied pigment-containing layers (pigments of the insulating layer, the color layer, or the heat-sensitive layer).

Without being bound by this theory, the inventors have noticed that the less pigment is contained in the protective layer, the higher the Bekk smoothness can be set, which in turn is advantageous for the sensitivity of the heat-sensitive recording material. Surprisingly, it has been shown that the proportion of pigments in the protective layer can be reduced, and the protective effect for certain requirements does not suffer. Furthermore, it has been shown that the relative print contrast can even be increased and/or improved as a result.

The at least one pigment is preferably selected from organic and/or inorganic pigments.

Suitable inorganic pigments comprise inorganic pigments, both of synthetic and natural origin, preferably clays, precipitated or natural calcium carbonates, aluminum oxides, aluminum hydroxides, silicas, precipitated and fumed silicas (e.g., Aerodisp types), diatomaceous earths, magnesium carbonates, talc, kaolin, titanium oxide, bentonite, but also organic pigments such as hollow pigments with a styrene-acrylate copolymer wall or urea/formaldehyde condensation polymers. These can be used alone or in any mixture.

Suitable organic pigments include hollow pigments with a styrene-acrylate copolymer wall or urea-formaldehyde condensation polymers. These can be used alone or in any mixture.

The protective layer is further preferably characterized in that the protective layer comprises at least one of the following components selected from
a binding agent,
a lubricant/release agent, particularly based on waxes or fats, fatty acids or salts of fatty acids, or silicones,
a crosslinking agent, in particular a boron-free crosslinking agent, and/or
a rheology additive.

Preferably, the protective layer comprises at least one binder.

Suitable binders include water-soluble starches, starch derivatives, starch-based biolatices of the EcoSphere type, methyl cellulose, hydroxyethyl cellulose, carboxymethyl cellulose, partially or fully saponified polyvinyl alcohols, chemically modified polyvinyl alcohols such as acetoacetyl-, diacetone-, carboxy-, silanol-modified polyvinyl alcohols, or styrene-maleic anhydride copolymers, styrene-butadiene copolymers, acrylamide-(meth)acrylate copolymers, acrylamide-acrylate-methacrylate terpolymers, polyacrylates, poly(meth)acrylic acid esters, acrylate-butadiene copolymers, polyvinyl acetates, and/or acrylonitrile-butadiene copolymers. These can be used alone or in any mixture.

Particularly preferably, the binder comprises polyvinyl alcohol, most preferably a polyvinyl alcohol with a degree of saponification of more than 88%.

The binder is preferably present in the protective layer in an amount of about 40 to about 90% by weight, particularly preferably in an amount of about 50 to about 80% by weight, based on the total solids content of the protective layer.

In order to achieve specific application-related performance characteristics of heat-sensitive recording materials, the binder is preferably present in a crosslinked form in the protective layer, wherein the optimum degree of crosslinking of the binder is achieved in the drying step of the coating process in the presence of a crosslinking agent (crosslinker).

The crosslinking agents may be polyvalent aldehydes such as glyoxal, dialdehyde starch, glutaraldehyde, optionally in a mixture with boron salts (borax), salts or esters of glyoxylic acid, crosslinkers based on ammonium zirconium carbonate, polyamidoamine-epichlorohydrin resins (PAE resins), adipic acid dihydrazide (AHD), boric acid or its salts, polyamines, epoxy resins, formaldehyde oligomers, cyclic ureas, methylol urea, melamine formaldehyde oligomers, etc. These can be used alone or in any mixture.

Boron-free crosslinking agents are preferred.

Ammonium zirconium carbonate and polyamidoamine-epichlorohydrin resins (PAE resins) are particularly preferred for reasons of food conformity.

Self-crosslinking binders, such as specially modified polyvinyl alcohols or acrylates, enable crosslinking without any crosslinking agents due to the reactive, crosslinkable groups that are already incorporated in the binder polymer.

The crosslinker is preferably present in an amount of about 0.01 to about 25.0, particularly preferably in an amount of about 0.05 to about 15.0%, based on the total solids content of the color layer.

The crosslinker is preferably present in an amount of about 0.01 to about 25.0, particularly preferably in an amount of about 0.05 to about 15.0, based on the total solids content of the protective layer.

Preferably, the protective layer comprises at least one lubricant or at least one release agent.

These agents preferably are fatty acid metal salts, such as, e.g., zinc stearate or calcium stearate, or even behenate salts, synthetic waxes, e.g., in the form of fatty acid amides such as, e.g., stearic acid amid and behenic acid amide, fatty acid alkanolamides such as, e.g., stearic acid methylolamide, paraffin waxes of different melting points, ester waxes of different molecular weights, ethylene waxes, propylene waxes of different hardnesses and/or natural waxes, such as, e.g., carnauba wax, montan wax, or soy wax.

Lubricants based on waxes or fats, fatty acids or salts of fatty acids are preferred.

The lubricant is preferably present in an amount of about 1 to about 30% by weight, particularly preferably in an amount of about 2 to about 20% by weight, based on the total solids content of the protective layer.

Preferably, the protective layer comprises at least one release agent.

For this, release agents based on silicones are preferred, which are known, for example, from US 2006/0063013 A1, the disclosure of which is hereby fully incorporated.

The release agent is preferably present in an amount of about 1 to about 30% by weight, particularly preferably in an amount of about 2 to about 20% by weight, based on the total solids content of the protective layer.

Preferably, the protective layer comprises at least rheology additives.

Preferred rheology additives are thickeners and surfactants.

Preferably, the protective layer comprises at least one lubricant/release agent, at least one binder and at least one crosslinking agent.

To control the surface whiteness of the heat-sensitive recording material according to the invention, optical brighteners, preferably stilbenes, can be incorporated into the protective layer.

Preferably, the protective layer has a basis weight in the range of 0.01 and 3.5 g/m², preferably in the range of more than 0.05 and 2.5 g/m². and particularly preferably in the range of 0.1 and 1.5 g/m².

Surprisingly, it has been shown that the basis weight of the protective layer can be reduced and the protective effect for certain requirements does not suffer. At the same time, the relative print contrast can even be increased and/or improved.

The protective layer preferably has a thickness of 0.3 to 6.0 μm, in particular 0.5 to 2.0 μm.

Preferably, the protective layer has a “non-stick effect”, in particular compared to an adhesive layer on the back of the heat-sensitive recording material.

Preferably, the protective layer has a “non-stick effect” towards pressure-sensitive adhesives, in particular on the back of the heat-sensitive recording material.

This has the advantage that the heat-sensitive recording material can be used as a linerless or unsupported heat-sensitive recording material.

In particular, this also has the advantage that the heat-sensitive recording material can be wound onto itself without the need for a support (“linerless” or “unsupported”), wherein after the heat-sensitive recording material wound onto itself has been rolled out again, the heat-sensitive recording material does not exhibit any deterioration in its paper and application properties.

Further, this has the advantage that the manufacturing costs can be further reduced, more running meters per roll can be realized, no disposal costs are required for the disposal of the liner and more labels can be transported per specific loading space volume.

In another preferred embodiment, the heat-sensitive recording material is preferably characterized in that an adhesive layer is present on the support material in sheet form on the side on which the color layer is not located.

If a starch precoat is present, this is located between the web-like backing material and the adhesive layer.

The adhesive layer preferably comprises at least one adhesive, preferably a heat-activated adhesive, in particular a pressure-sensitive adhesive.

It is particularly preferred that the adhesive, preferably the heat-activated adhesive and in particular the pressure-sensitive adhesive, is a rubber-based and/or acrylate-based adhesive.

Preferably, the protective layer has a “non-stick effect” towards the rubber-based and/or acrylate-based adhesives.

The adhesive layer preferably has a basis weight of 1 to 40 g/m², in particular 12 to 25 g/m².

In another preferred embodiment, the heat-sensitive recording material is preferably characterized in that a siliconized release layer is present on the heat-sensitive layer.

The terms “siliconized release layer” and “siliconized layer” are to be understood synonymously in the sense of “covered with a layer of silicone”. Preferably, these layers consist of silicone or comprise at least 90% by weight, preferably at least 95% by weight and particularly preferably at least 99% by weight and most preferably only silicone except for unavoidable traces or additives (e.g., for UV curing of a siliconization liquid).

The siliconized release layer preferably has a Bekk smoothness of more than 400 s, particularly preferably more than 800 s and most preferably from 800 to 2000 s.

If a protective layer, in particular as defined above, is present on the heat-sensitive layer, the siliconized release layer is preferably located on this protective layer.

In another preferred embodiment, the heat-sensitive recording material is preferably characterized in that a diffusion layer is formed between the siliconized layer and the underlying layer, preferably the heat-sensitive layer. This diffusion layer is preferably formed by diffusion of at least parts of the siliconized release layer into the upper area of the layer below, wherein preferably 5 to 50% by weight, particularly preferably 6 to 45% by weight and in particular 7 to 40% by weight of the siliconized release layer diffuse into the upper area of the underlying layer. Such a diffusion layer is described, for example, in EP 3 221 153 A1.

A siliconized release layer is preferably present if an adhesive layer, as described above, is also present.

The presence of a siliconized release layer on the heat-sensitive layer and an adhesive layer on the support material in sheet form on the side on which the color layer is not located has the advantage that the heat-sensitive recording material can be used as a linerless heat-sensitive recording material.

In particular, this has the advantage that the heat-sensitive recording material can be wound onto itself without the need for a support (“linerless”), wherein after the heat-sensitive recording material wound onto itself has been rolled out again, the heat-sensitive recording material does not exhibit any significant deterioration in its properties.

Further, this has the advantage that the manufacturing costs can be further reduced, more running meters per roll can be realized, no disposal costs are required for the disposal of the liner and more labels can be transported per specific loading space volume.

If a siliconized release layer is present, it is preferred that at least one platelet-like pigment is contained in the layer directly below the siliconized release layer.

The at least one platelet-like pigment is preferably selected from the group consisting of kaolin, Al(OH)₃ and/or talc. The use of kaolin is particularly preferred. The use of a coating kaolin is particularly preferred. Such a product is available, for example, under the trade name Kaolin ASP 109 (BASF, Germany).

The main advantage of using these platelet-like pigments, in particular kaolin, is that the heat-sensitive layer or the layer directly below the siliconized release layer can be siliconized very easily.

Platelet pigment is understood to be a pigment in which the ratio of diameter to thickness is about 7 to 40:1, preferably about 15 to 30:1.

The particle size of the platelet-like pigment is preferably adjusted such that at least about 70%, preferably at least about 85%, of the particles have a particle size of about <2 μm (sedigraph). The pH value of the platelet-like pigment in aqueous solution preferably is 6 to 8.

The at least one platelet-shaped pigment is present in the heat-sensitive color-forming layer or in the layer lying directly below the siliconized release layer, preferably in an amount of about 5 to about 60% by weight, particularly preferably in an amount of about 15 to about 55% by weight, based on the total solids content of the respective layer.

If the protective layer is present directly below the siliconized release layer, the platelet-shaped pigment is contained in the amounts described above for the pigments contained in the protective layer.

In another preferred embodiment, the heat-sensitive recording material is preferably characterized in that the siliconized release layer comprises at least one siloxane, preferably a poly (organo) siloxane, in particular an acrylic poly (organo) siloxane.

In another embodiment, the siliconized release layer comprises a mixture of at least two siloxanes. A mixture of at least two acrylic poly (organo) siloxanes is preferred.

Examples of particularly preferred siloxanes are siloxanes available under the trade names TEGO®RC902 and TEGO®RC711 (Evonik, Germany).

In another embodiment, the heat-sensitive recording material is preferably characterized in that the siliconized release layer comprises at least one polysilicone acrylate, preferably formed by condensation of at least one silicone acrylate.

In a preferred embodiment, the siliconized release layer is a heat-cured release layer. Forming of this release layer is performed in the presence of a Pt catalyst.

The siliconized release layer is preferably anhydrous. It is also preferred that the siliconized release layer does not contain any Pt catalysts.

The siliconized release layer preferably contains an initiator, particularly preferably a photoinitiator. This is used for radical curing of the silicone.

The TEGO® photoinitiator A18 (from Evonik, Germany) is particularly preferred.

The siliconized release layer can preferably contain further additives, such as matting agents and/or adhesion additives.

The siliconized release layer preferably has a basis weight of 0.3 to 5.0 g/m², more particularly 1.0 to 3.0 g/m².

The siliconized release layer preferably has a thickness of 0.3 to 6.0 μm, more particularly 0.5 to 2.0 μm.

In another preferred embodiment, the heat-sensitive recording material is preferably characterized in that the heat-sensitive recording material has a residual moisture content of 2 to 14%, preferably of 2 to 12%, and most preferably of 3 to 10%. A residual moisture content of 3 to 8% is most preferable.

The residual moisture can be determined as described in connection with the examples.

It is assumed that the opacity in the heat-sensitive layer is generated not only by the scattering particles, in particular the polymer particles, themselves, but also by the air trapped between the scattering particles, in particular the polymer particles (open porosity). The penetration of moisture into these “pores” will displace air and reduce opacity. This can result in a grayer material, which is not preferred.

In another preferred embodiment, the heat-sensitive recording material is preferably characterized in that the heat-sensitive recording material has a surface whiteness of 35 to 60%, more particularly of 45 to 50%.

A residual moisture content in the specified ranges has the advantage that after printing there is a high relative print contrast with advantageous application properties, such as better legibility.

The surface whiteness (paper whiteness) can be determined in accordance with ISO 2470-2 (2008) using an Elrepho 3000 spectrophotometer.

In another preferred embodiment, the heat-sensitive recording material is preferably characterized in that the contrast between locations where the heat-sensitive layer has become translucent due to application of localized heat, and locations where the heat-sensitive layer has not become translucent due to application of localized heat is 40 to 80%, in particular from 50 to 70%.

This contrast can be calculated by taking the difference between the optical density of the background and the typeface. The optical density (OD) is measured using a densitometer, for example.

In another preferred embodiment, the heat-sensitive recording material is preferably characterized in that it has a deposition behavior of at least “grade 2” in a thermal printer endurance test (10 km). After a test run of 10 km on a commercially available thermal printer (model: Zebra ZD420), a visual inspection for depositions on the thermal print head was carried out. The assessment was based on the following grading system: Grade 0 =no depositions, grade 1=slight depositions, grade 2=medium depositions, grade 3=severe depositions.

Marketable heat-sensitive recording materials show no depositions (grade 0).

In another preferred embodiment, the heat-sensitive recording material is preferably characterized in that it has a water-wet abrasion resistance of 5 to 10 (absorbance values, based on a photometric determination after the end of the test), preferably of less than 5.

The water-wet abrasion resistance of the heat-sensitive recording materials is preferably evaluated using a wet-rub tester (type NSE-1IR) from the Adams Co. and a photometer (DR3900) from the Hach-Lange Co. For this, an unprinted strip (210×24 mm) of the heat-sensitive recording material is provided with double-sided adhesive tape on the back and stuck onto the guide roller of the wet-rub tester. 30 ml of distilled water are added into the so-called sample tray before the wet-rub tester is switched on. The guide roller is lowered onto the drive roller. After 50 s, the guide roller is lifted from the drive roller. The drive roller is rinsed with 10 ml of distilled Water. The rinsing water is collected in the sample tray. Subsequently, the turbidity of the water is determined as absorbance by means of the photometer. The following evaluation scale is used to assess wet abrasion resistance based on the extinction values: <5 corresponds to very good, 5-10 corresponds to good, and 10-20 corresponds to satisfactory.

In another preferred embodiment, the thermally sensitive recording material is preferably characterized in that it has a dynamic color density (dynamic sensitivity) with an image density (optical density, OD) of at least 1.35, preferably 1.38-2% (measured at an energy level of 12.79 mJ/mm²). The determination of the dynamic color density (dynamic sensitivity) is preferably performed as defined in the examples.

All of the above layers can be single-or multi-layered.

The heat-sensitive recording material according to the invention can be obtained using known manufacturing processes.

The present invention also relates to a manufacturing process for a heat-sensitive recording material as described above.

It is preferred to obtain the heat-sensitive recording material according to the invention by a process in which (aqueous) suspensions comprising the starting materials of the individual layers are successively applied to the support material in sheet form, the (aqueous) application suspensions having a solids content of 8 to 50% by weight, preferably of 10 to 40% by weight, and being applied by the curtain coating process at an operating speed of the coating system of at least 200 m/min, in particular at least 900 m/min.

This process is particularly advantageous from an economic point of view and due to the even application over the support material in sheet form.

If the solids content falls below a value of around 8% by weight, the economic efficiency deteriorates because a large amount of water has to be removed in a short time by gentle drying, which has a detrimental effect on the coating speed.

If, on the other hand, the value of 60% by weight is exceeded, the only effect is an increased technical effort to ensure the stability of the coating color curtain during the coating process and the drying of the applied film, since the machine has to run very quickly again in this case.

In the curtain coating process, a free-falling curtain of a coating dispersion is formed. The coating dispersion in the form of a thin film (curtain) is “poured” onto a substrate by free fall in order to apply the coating dispersion to the substrate. DE 10 196 052 T1 discloses the use of the curtain coating process in the production of information recording materials, wherein multilayer recording layers are realized by applying the curtain, which consists of several coating dispersion films, to substrates.

Embodiments of the process according to the invention in which a “double curtain” is used may also be contemplated. This means that two successive coats are applied one immediately after the other. The application is carried out in such immediate succession that the first layer applied has not yet dried before the next layer is applied. The two layers are therefore preferably applied “wet on wet”.

All definitions relating to the curtain coating process apply analogously to the double curtain coating process.

The advantage of a “wet-on-wet” application using a double curtain coating process is that the two layers have a stronger bonding and, more particularly, there is no need for intermediate adhesion promoters.

In a preferred embodiment of the process according to the invention, the aqueous, deaerated application suspension has a viscosity of about 100 to about 1000 mPas (Brookfield, 100 rpm, 20° C.). If the value drops below about 100 mPas or exceeds about 1000 mPas, this leads to poor runnability of the coating mass on the coating unit. Particularly preferably, the viscosity of the aqueous, deaerated application suspension is about 200 to about 500 mPas. The viscosities of successive coating masses in the double curtain should decrease from bottom to top. Incorrectly adjusted coatings increase the probability of heeling at the point of impact of the curtain as well as the occurrence of “wetting faults”.

In a preferred embodiment, the surface tension of the aqueous application suspension can be adjusted to about 25 to about 70 mN/m, preferably to about 35 to about 60 mN/m (measured in accordance with the standard for bubble pressure tensiometry (ASTM D 3825-90), as described below), in order to optimize the process. Better control over the coating process can be achieved by determining the dynamic surface tension of the coating color and adjusting it by selecting the appropriate surfactant and determining the required amount of surfactant.

The dynamic surface tension is measured using a bubble pressure tensiometer. The maximum internal pressure of a gas bubble formed via a capillary in a liquid is measured. According to the Young-Laplace equation, the internal pressure p of a spherical gas bubble (Laplace pressure) depends on the radius of curvature r and the surface tension σ:

$$p = \frac{2 σ}{r}$$

When a gas bubble is produced at the tip of a capillary in a liquid, the curvature first increases and then decreases again, resulting in the occurrence of a pressure maximum of. The greatest curvature and thus the greatest pressure occur when the radius of curvature corresponds to the capillary radius.

Pressure characteristics for the bladder pressure measurement, position of the pressure maximum:

The radius of the capillary is determined using a reference measurement carried out with a liquid with a known surface tension, usually water. Once the radius is known, the surface tension can be calculated from the maximum pressure, pmax. Since the capillary is immersed in the liquid, the hydrostatic pressure p0 resulting from the immersion depth and the density of the liquid must be subtracted from the measured pressure (this is done automatically with modern instruments). This results in the following formula for the bubble pressure process:

$$σ = \frac{( {p}_{max} - {p}_{0} ) \cdot r}{2}$$

The measured value corresponds to the surface tension at a certain surface age, the time from the start of bubble formation to the occurrence of the pressure maximum. By varying the speed at which the bubbles are produced, the dependence of the surface tension on the surface age can be acquired, resulting in a curve in which the surface tension is plotted against time.

This dependency plays an important role in the use of surfactants, as the equilibrium value of the interfacial tension is not even reached in many processes due to the sometimes low diffusion and adsorption rates of surfactants.

The individual layers can be formed on-line or in a separate off-line coating process.

In particular, to ensure that the layers described in detail above exhibit the aforementioned Bekk smoothing, the following process steps are preferably carried out.

The support material in sheet form is preferably smoothed in a first cylinder. This one-sided or two-sided high smoothness, which is produced by this process technology, already provides the support material in sheet form with an advantage. Additional calendering by a downstream calender, preferably before a first coater, can further improve smoothness and/or ensure a good profile.

If a starch coating as defined above is applied, this is preferably done using a film press before the color layer is applied using a blade coater.

The starch on the back side is particularly advantageous to prevent the coating color from penetrating the blade coater.

It would also be possible to apply the color layer directly with a film press. However, there would be a disadvantage in terms of smoothness compared to a blade coater. The use of a blade coater gives the material a good basic smoothness for the important dynamic color density (dynamic sensitivity) of the end product. There is a correlation between final smoothness and dynamic sensitivity.

It could also be contemplated to apply the color layer with a film press or even with a curtain coater. The advantage of smoothness is then lost, but this could be compensated, in particular when using a film press, with a calender. However, this is only appropriate if no hollow spheres are used, as these would be destroyed by the film press.

The insulating layer, if present, is applied in the same way.

The siliconized layer, if present, is also applied in the same way.

The same applies to the protective layer. Alternatively, the protective layer can also be printed on. In terms of processing and technological properties, protective coatings that can be cured using actinic radiation are particularly suitable. The term “actinic radiation” refers to UV or ionizing radiation, such as electron beams.

Application of the heat-sensitive layer is preferably done by means of curtain coating, as described above.

If support materials in sheet form, in particular papers, are coated on one side, the resulting curl should then be evened out.

This is preferably done with an LAS moisturizer (LAS Liquid Applicator System). To do this, a film of water is applied to the lesser coated side and then dried.

This restores the so-called flat position. When the water film is applied, the surface deteriorates slightly.

A preferred variant for protecting the surface would be a steam humidifier. Instead of water, steam is blown on. This does not damage the surface. This is very suitable for applications where the highest surface quality must be achieved.

Another option would be a spray humidifier, where a water mist is applied.

All of the above layers can be single-or multi-layered.

The present invention further relates to a heat-sensitive recording material obtainable by the process described above.

The present invention also relates to the use of a heat-sensitive recording material as described above as a receipt roll, adhesive label (roll), ticket (roll) or as printer paper for mechanical printers or writing pens, wherein these may in particular have a functional side and/or reverse side (with color, colored, black/gray) and may be pre-printed. Said rolls are preferably available in typical widths and lengths.

### DESCRIPTION OF THE FIGURES

The following figures schematically illustrate various layer structures for exemplary heat-sensitive recording materials according to the invention. The composition of the individual layers is to be understood as defined above for each layer. The advantages of the heat-sensitive recording materials according to the invention set out in the present description apply in particular to the preferred embodiments described below.

These figures also describe particularly preferred embodiments of the invention.

FIG. 1: Heat-sensitive recording material having a support material in sheet form, a color layer applied thereto, and a heat-sensitive layer on the color layer, wherein a protective layer is applied to the heat-sensitive layer.

FIG. 2: Heat-sensitive recording material having a support material in sheet form, a color layer applied thereto, which is also an insulating layer, and a heat-sensitive layer on the color layer, wherein a protective layer is applied to the heat-sensitive layer.

FIG. 3: A heat-sensitive recording material having a support material in sheet form, an insulating layer applied thereto, a color layer applied thereto, and a heat-sensitive layer on the color layer, wherein a protective layer is applied to the heat-sensitive layer.

FIG. 4: Heat-sensitive recording material having a support material in sheet form having a starch precoat on both sides, a color layer applied thereto, and a heat-sensitive layer on the color layer, wherein a protective layer is applied to the heat-sensitive layer.

FIG. 5: Heat-sensitive recording material having a support material in sheet form, having a starch precoat on both sides, a color layer, which is also an insulating layer, applied thereto, and a heat-sensitive layer on the color layer, wherein a protective layer is applied to the heat-sensitive layer.

FIG. 6: Heat-sensitive recording material having a support material in sheet form, having a starch precoat on both sides, an insulating layer applied thereto, a color layer applied thereto, and a heat-sensitive layer on the color layer, wherein a protective layer is applied to the heat-sensitive layer.

FIG. 7: Heat-sensitive recording material having a support material in sheet form, a color layer applied thereto, and a heat-sensitive layer on the color layer, wherein a protective layer is applied to the heat-sensitive layer, and wherein a siliconized layer is applied to the protective layer.

FIG. 8: Heat-sensitive recording material having a support material in sheet form, a color layer applied thereto, which is also an insulating layer, and a heat-sensitive layer on the color layer, wherein a protective layer is applied to the heat-sensitive layer, and wherein a siliconized layer is applied to the protective layer.

FIG. 9: Heat-sensitive recording material having a support material in sheet form, an insulating layer applied thereto, a color layer applied thereto, and a heat-sensitive layer on the color layer, wherein a protective layer is applied to the heat-sensitive layer, and wherein a siliconized layer is applied to the protective layer.

FIG. 10: Heat-sensitive recording material having a support material in sheet form, having a starch precoat on both sides, a color layer applied thereto, and a heat-sensitive layer on the color layer, wherein a protective layer is applied to the heat-sensitive layer, and wherein a siliconized layer is applied to the protective layer.

FIG. 11: Heat-sensitive recording material having a support material in sheet form, having a starch precoat on both sides, a color layer applied thereto, which is also an insulating layer, and a heat-sensitive layer on the color layer, wherein a protective layer is applied to the heat-sensitive layer, and wherein a siliconized layer is applied to the protective layer.

FIG. 12: Heat-sensitive recording material having a support material in sheet form, having a starch precoat on both sides, an insulating layer applied thereto, a color layer applied thereto, and a heat-sensitive layer on the color layer, wherein a protective layer is applied to the heat-sensitive layer, and wherein a siliconized layer is applied to the protective layer.

FIG. 13: Heat-sensitive recording material having a support material in sheet form, an adhesive layer on the lower side, and a color layer applied to the other side of the support material in sheet form, and a heat-sensitive layer on the color layer, wherein a protective layer is applied to the heat-sensitive layer.

FIG. 14: Heat-sensitive recording material having a support material in sheet form, an adhesive layer on the lower side, and a color layer applied to the other side of the support material in sheet form, which is also an insulating layer, and a heat-sensitive layer on the color layer, wherein a protective layer is applied to the heat-sensitive layer.

FIG. 15: Heat-sensitive recording material having a support material in sheet form, an adhesive layer on the lower side and an insulating layer applied to the other side of the support material in sheet form, a color layer applied thereto, and a heat-sensitive layer on the color layer, wherein a protective layer is applied to the heat-sensitive layer.

FIG. 16: Heat-sensitive recording material having a support material in sheet form, having a starch precoat on both sides, an adhesive layer on the lower side and a color layer applied to the other side of the support material in sheet form, and a heat-sensitive layer on the color layer, wherein a protective layer is applied to the heat-sensitive layer.

FIG. 17: Heat-sensitive recording material having a support material in sheet form, having a starch precoat on both sides, an adhesive layer on the lower side, and a color layer, which is also an insulating layer, applied to the other side of the support material in sheet form, and a heat-sensitive layer on the color layer, wherein a protective layer is applied to the heat-sensitive layer.

FIG. 18: Heat-sensitive recording material having a support material in sheet form, having a starch precoat on both sides, an adhesive layer on the lower side and an insulating layer applied to the other side of support material in sheet form, a color layer applied thereto, and a heat-sensitive layer on the color layer, wherein a protective layer is applied to the heat-sensitive layer.

FIG. 19: Heat-sensitive recording material having a support material in sheet form, an adhesive layer on the lower side, and a color layer applied to the other side of the support material in sheet form, and a heat-sensitive layer on the color layer, wherein a protective layer is applied to the heat-sensitive layer, and wherein a siliconized layer is applied to the protective layer.

FIG. 20: Heat-sensitive recording material having a support material in sheet form, an adhesive layer on the lower side, and a color layer, which is also an insulating layer, applied to the other side of the support material in sheet form, and a heat-sensitive layer on the color layer, wherein a protective layer is applied to the heat-sensitive layer, and wherein a siliconized layer is applied to the protective layer.

FIG. 21: Heat-sensitive recording material having a support material in sheet form, an adhesive layer on the lower side and an insulating layer applied to the other side of the support material in sheet form, a color layer applied thereto, and a heat-sensitive layer on the color layer, wherein a protective layer is applied to the heat-sensitive layer, and wherein a siliconized layer is applied to the protective layer.

FIG. 22: Heat-sensitive recording material having a support material in sheet form, having a starch precoat on both sides, an adhesive layer on the lower side, and a color layer applied to the other side of the support material in sheet form, and a heat-sensitive layer on the color layer, wherein a protective layer is applied to the heat-sensitive layer, and wherein a siliconized layer is applied to the protective layer.

FIG. 23: Heat-sensitive recording material having a support material in sheet form, having a starch precoat on both sides, an adhesive layer on the lower side, and a color layer, which is also an insulating layer, applied to the other side of the support material in sheet form, and a heat-sensitive layer on the color layer, wherein a protective layer is applied to the heat-sensitive layer, and wherein a siliconized layer is applied to the protective layer.

FIG. 24: Heat-sensitive recording material having a support material in sheet form, having a starch precoat on both sides, an adhesive layer on the lower side and an insulating layer applied to the other side of the support material in sheet form, a color layer applied thereto, and a heat-sensitive layer on the color layer, wherein a protective layer is applied to the heat-sensitive layer, and wherein a siliconized layer is applied to the protective layer.

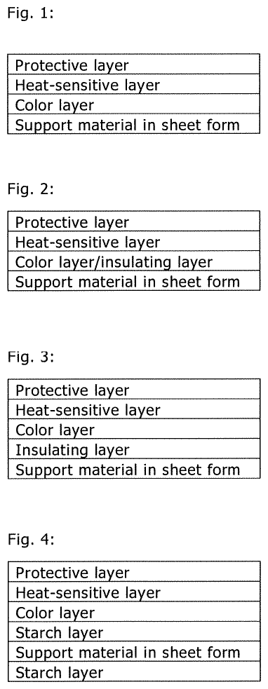

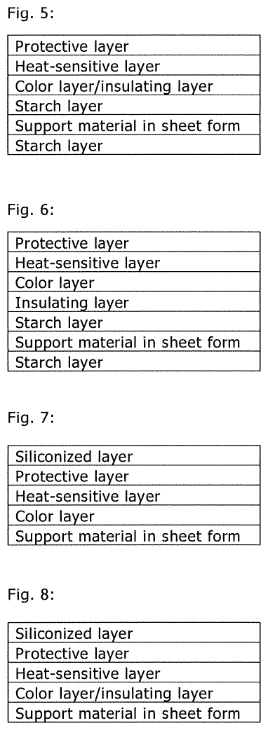

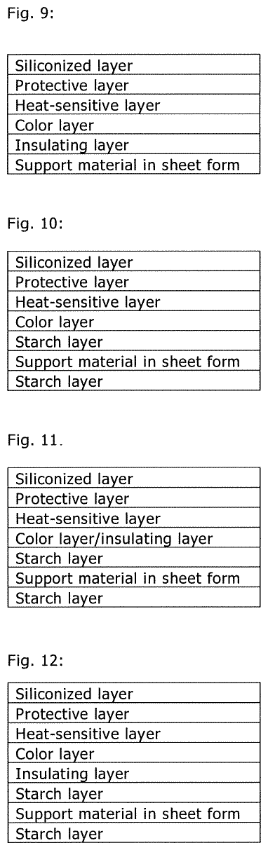

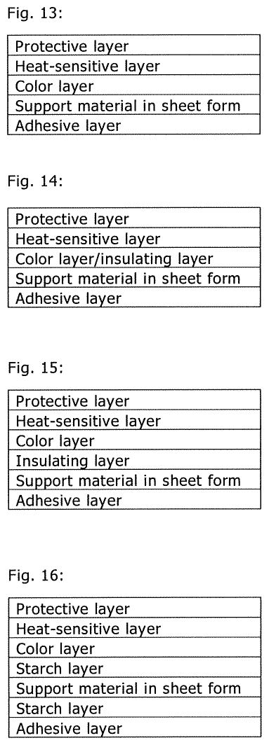

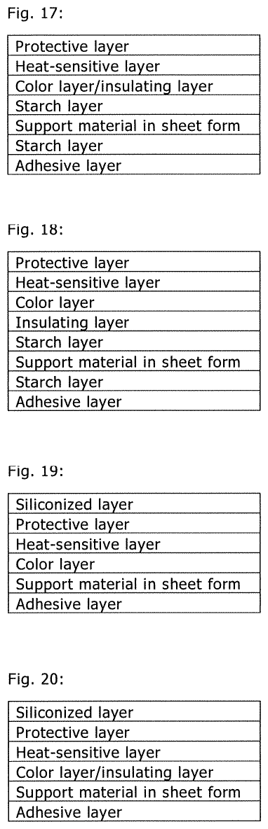

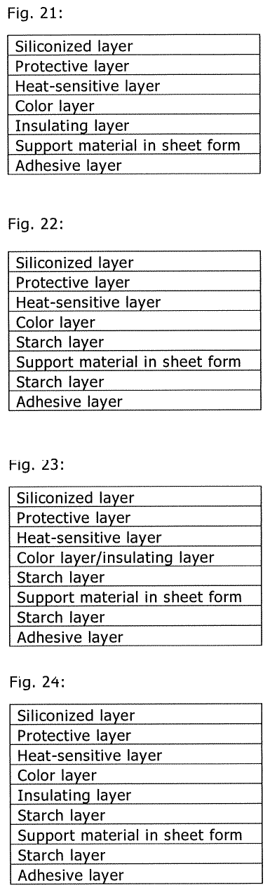

### EXAMPLES

The invention is explained in more detail below with reference to several non-limiting examples:

Heat-sensitive recording materials according to the invention were prepared with the compositions according to Tables 1 to 6 and 8 to 13 and a comparative example according to Table 7.

In all examples, a paper substrate made of hardwood and softwood pulp with a basis weight of 41 or 58 g/m² is used as the support material.

All indicated basis weights refer to the respective dried layer.

The dry contents (DW) of the respective coating formulations are adjusted by adding water as follows: insulating layer (30%), color layer (26%), heat-sensitive layer (20%) and protective layer (10%).

The raw materials are used as a dispersion or solution with the following dry contents: Ropaque HP-1055 (21%), styrene butadiene latex (48%), carbon black (45%), Ropaque OP-96 (30%), sodium metaborate tetrahydrate (2%), stearic acid amide wax (22%), silicon oxide (28%), zinc stearate (35%), polyvinyl alcohol (high viscosity) (10%), calcined kaolin (45%), precipitated calcium carbonate (58%), ammonium zirconium carbonate (9%), polyamidoamine epichlorohydrin (10%), polyvinyl alcohol (low viscosity) (7%), and kaolin (75%).

The quantities [% by weight] refer to the oven-dry state (ods).

In the exemplary embodiments 1 and 8, the insulating layer is applied to the paper substrate on a paper machine using a film press at a speed of 800 m/min.

The color layer and the heat-sensitive layer are applied consecutively by a single curtain coater and/or simultaneously by a double curtain coater at a speed of 900 m/min to the paper substrate provided with an insulating layer on a paper coating machine. The protective layer is applied to the heat-sensitive layer on a paper coating machine using a curtain coater at a speed of 900 m/min. After each application, the drying process of the respective coated paper carrier is carried out in the conventional manner without negatively affecting the properties of the heat-sensitive recording material according to the invention, such as the surface whiteness or paper whiteness of the heat-sensitive layer.

In the embodiments 2, 3, 9, and 10, the color layer and the heat-sensitive layer are applied consecutively by a single curtain coater and/or simultaneously by a double curtain coater to the paper substrate at a speed of 900 m/min on a paper coating machine. The protective layer is applied to the heat-sensitive layer on a paper coating machine using a curtain coater at a speed of 900 m/min. After each application, the drying process of the respective coated paper carrier is carried out in the conventional manner without negatively affecting the properties of the heat-sensitive recording material according to the invention, such as the surface whiteness or paper whiteness of the heat-sensitive layer.

In the exemplary embodiments 4, 6, 11, and 13 and in the comparative example 7, a starch precoat (0.5 g/m²) is applied to the front and back of the paper substrate on a paper machine using a film press at a speed of 800 m/min. The color layer is applied to the starch-coated paper substrate on a paper coating machine using a blade coater at a speed of 600 m/min. To the starch-coated paper substrate with a color layer, the heat-sensitive layer and the protective layer are applied consecutively using a single curtain coater and/or simultaneously using a double curtain coater at a speed of 900 m/min on a paper coating machine. After each application, the drying process of the respective coated paper carrier is carried out in the conventional manner without negatively affecting the properties of the heat-sensitive recording material according to the invention, such as the surface whiteness or paper whiteness of the heat-sensitive layer.

In the exemplary embodiments 5 and 12, the color layer and the heat-sensitive layer are applied consecutively by a single curtain coater and/or simultaneously by a double curtain coater to the paper substrate at a speed of 900 m/min on a paper coating machine. The protective layer is applied to the heat-sensitive layer on a paper coating machine using a curtain coater at a speed of 900 m/min. After each application, the drying process of the respective coated paper carrier is carried out in the conventional manner without negatively affecting the properties of the heat-sensitive recording material according to the invention, such as the surface whiteness or paper whiteness of the heat-sensitive layer.

On a laboratory scale, the aqueous application suspensions were applied consecutively to the paper substrate using a rod blade to form the color layer, heat-sensitive layer, and protective layer of a heat-sensitive recording material. After each application, drying was performed with a hot air dryer (40 cm distance) at a temperature range of 90 to 110° C. within 1 to 3 minutes.

TABLE 1
Composition of the individual layers of the heat-
sensitive recording material according to example 1.
Example 1

| | Formulation | Formulation | | Quantity |
|---|---|---|---|---|
| Layer | ingredient | ingredient | | [% by |
| basis weight | Trade name | Chemical name | Function | wt.] |
| Insulating layer | Ropaque HP-1055, | Styrene-acrylate | Scattering particles, | 41.1 |
| 2.5-3.0 g/m² | Dow Co. | copolymer | polymer particles | |
| | | Precipitated calcium | Inorganic pigment | 39.9 |
| | | carbonate, calcite type | | |
| | Poval, Kuraray Co. | Polyvinyl alcohol, | Binder | 3.0 |
| | | highly saponified, low | | |
| | | viscosity | | |
| | Latex, Styron Co. | Styrene-butadiene | Binder | 15.5 |
| | | latex | | |
| | n.a. | n.a. | Rheology additives | Balance |
| Color layer | | Kaolin | Inorganic pigment | 67.4 |
| 3.5 g/m² | | | | |
| | Poval, Kuraray Co. | Polyvinyl alcohol, | Binder | 20.0 |
| | | highly saponified, low | | |
| | | viscosity | | |
| | | Carbon black | Dye/color pigment | 12.0 |
| | n.a. | n.a. | Rheology additives | Balance |
| Heat-sensitive | Ropaque OP-96, | Styrene-acrylate | Polymer particles | 44.1 |
| layer | Dow Co. | copolymer | | |
| 3.5 g/m² | | Sodium metaborate | Crosslinker | 0.9 |
| | | tetrahydrate | | |
| | Chukyo Co. | Stearic acid amide wax | Heat-sensitive | 34.4 |
| | | | material | |
| | | Silicon oxide | Inorganic pigment | 8.0 |
| | | Zinc stearate | Lubricant/release | 3.9 |
| | | | agent | |
| | Poval, Kuraray Co. | Polyvinyl alcohol, | Binder | 8.3 |
| | | highly saponified, high | | |
| | | viscosity | | |
| | n.a. | n.a. | Rheology additives | Balance |
| Protective layer | Poval, Kuraray Co. | Polyvinyl alcohol, | Binder | 89.0 |
| 1.0 g/m² | | highly saponified, high | | |
| | | viscosity | | |
| | | Zinc stearate | Lubricant/release | 4.0 |
| | | | agent | |
| | | Sodium metaborate | Crosslinker | 5.0 |
| | | tetrahydrate | | |
| | n.a. | n.a. | Rheology additives | Balance |

n.a.: Common materials known to those skilled in the art.

TABLE 2
Composition of the individual layers of the heat-
sensitive recording material according to example 2.
Example 2

| | Formulation | Formulation | | Quantity |
|---|---|---|---|---|
| Layer | ingredient | ingredient | | [% by |
| basis weight | Trade name | Chemical name | Function | wt.] |
| Color layer | Ropaque HP-1055, | Styrene-acrylate | Scattering | 52.3 |
| 5.2 g/m² | Dow Co. | copolymer | particles/polymer | |
| | | | particles | |
| | Latex, Styron Co. | Styrene-butadiene | Binder | 25.7 |
| | | latex | | |
| | | Carbon black | Dye/color pigment | 21.2 |
| | n.a. | n.a. | Rheology additives | Balance |
| Heat-sensitive | Ropaque OP-96, | Styrene-acrylate | Scattering particles, | 35.1 |
| layer | Dow Co. | copolymer | polymer particles | |
| 3.5 g/m² | | Sodium metaborate | Crosslinker | 0.7 |
| | | tetrahydrate | | |
| | Chukyo Co. | Stearic acid amide wax | Heat-sensitive material | 40.4 |
| | | Silicon oxide | Inorganic pigment | 9.0 |
| | | Zinc stearate | Lubricant/release agent | 3.2 |
| | Poval, Kuraray Co. | Polyvinyl alcohol, | Binder | 8.3 |
| | | highly saponified, high | | |
| | | viscosity | | |
| | n.a. | n.a. | Rheology additives | Balance |
| Protective layer | Poval, Kuraray Co. | Polyvinyl alcohol, | Binder | 89.0 |
| 1.0 g/m² | | highly saponified, high | | |
| | | viscosity | | |
| | | Zinc stearate | Lubricant/release agent | 4.0 |
| | | Sodium metaborate | Crosslinker | 5.0 |
| | | tetrahydrate | | |
| | n.a. | n.a. | Rheology additives | Balance |

n.a.: Common materials known to those skilled in the art.

TABLE 3
Composition of the individual layers of the heat-
sensitive recording material according to example 3.
Example 3

| | Formulation | Formulation | | Quantity |
|---|---|---|---|---|
| Layer | ingredient | ingredient | | [% by |
| basis weight | Trade name | Chemical name | Function | wt.] |
| Color layer | Ropaque HP-1055, | Styrene-acrylate | Scattering | 47.2 |
| 7.5 g/m² | Dow Co. | copolymer | particles/polymer | |
| | | | particles | |
| | | Kaolin | Inorganic pigment | 16.2 |
| | Latex, Styron Co. | Styrene-butadiene | Binder | 12.8 |
| | | latex | | |
| | | Carbon black | Dye/color pigment | 23.3 |
| | n.a. | n.a. | Rheology additives | Balance |
| Heat-sensitive | Plastic Pigment | Styrene polymer | Scattering | 35.3 |
| layer | 756A, Trinseo LLC | | particles/polymer | |
| 4.0 g/m² | | | particles | |
| | Chukyo Co. | Stearic acid amide wax | Heat-sensitive material | 30.8 |
| | Latex, Styron Co. | Styrene-butadiene | Binder | 10.3 |
| | | latex | | |
| | | Zinc stearate | Lubricant/release agent | 3.5 |
| | | Precipitated calcium | Inorganic pigment | 6.0 |
| | | carbonate, calcite type | | |
| | | Silicon oxide | Inorganic pigment | 9.0 |
| | n.a. | n.a. | Rheology additives | Balance |
| Protective layer | Poval, Kuraray Co. | Polyvinyl alcohol, | Binder | 79.0 |
| 1.0 g/m² | | highly saponified, high | | |
| | | viscosity | | |
| | | Zinc stearate | Lubricant/release agent | 4.0 |
| | | Ammonium zirconium | Crosslinker | 15.0 |
| | | carbonate | | |
| | n.a. | n.a. | Rheology additives | Balance |

n.a.: Common materials known to those skilled in the art.

TABLE 4
Composition of the individual layers of the heat-
sensitive recording material according to example 4.
Example 4

| | Formulation | Formulation | | Quantity |
|---|---|---|---|---|
| Layer | ingredient | ingredient | | [% by |
| basis weight | Trade name | Chemical name | Function | wt.] |
| Color layer | | Calcined kaolin | Inorganic pigment | 52.2 |
| 7.0 g/m² | | Precipitated calcium | Inorganic pigment | 16.9 |
| | | carbonate, calcite type | | |
| | Latex, Styron Co. | Styrene-butadiene | Binder | 12.6 |
| | | latex | | |
| | | Carbon black | Dye/Color pigment | 19.0 |
| | n.a. | n.a. | Rheology additives | Balance |
| Heat-sensitive | Ropaque OP-96, | Styrene-acrylate | Scattering particles, | 38.5 |
| layer | Dow Co. | copolymer | polymer particles | |
| 3.5 g/m² | | Ammonium zirconium | Crosslinker | 0.9 |
| | | carbonate | | |
| | Chukyo Co. | Stearic acid amide wax | Heat-sensitive | 51.0 |
| | | | material | |
| | Poval, Kuraray Co. | Polyvinyl alcohol, | Binder | 8.3 |
| | | highly saponified, high | | |
| | | viscosity | | |
| | n.a. | n.a. | Rheology additives | Balance |
| Protective layer | Poval, Kuraray Co. | Polyvinyl alcohol, | Binder | 79.0 |
| 1.0 g/m² | | highly saponified, high | | |
| | | viscosity | | |
| | | Zinc stearate | Lubricant/release | 4.0 |
| | | | agent | |
| | | Ammonium zirconium | Crosslinker | 15.0 |
| | | carbonate | | |
| | n.a. | n.a. | Rheology additives | Balance |

n.a.: Common materials known to those skilled in the art.

TABLE 5
Composition of the individual layers of the heat-
sensitive recording material according to example 5.
Example 5

| | Formulation | Formulation | | Quantity |
|---|---|---|---|---|
| Layer | ingredient | ingredient | | [% by |
| basis weight | Trade name | Chemical name | Function | wt.] |
| Color layer | | Precipitated calcium | Inorganic pigment | 40.3 |
| 4.0 g/m² | | carbonate, calcite type | | |
| | Latex, Styron Co. | Styrene-butadiene | Binder | 16.9 |
| | | latex | | |
| | | Carbon black | Dye/color pigment | 42.4 |
| | n.a. | n.a. | Rheology additives | Balance |
| Heat-sensitive | Chukyo Co. | Stearic acid amide wax | Scattering | 72.3 |
| layer | | | particles/heat- | |
| 6.0 g/m² | | | sensitive | |
| | | | material/lubricant | |
| | Poval, Kuraray Co. | Polyvinyl alcohol, | Binder | 12.8 |
| | | highly saponified, high | | |
| | | viscosity | | |
| | | Precipitated calcium | Inorganic pigment | 5.5 |
| | | carbonate, calcite type | | |
| | | Silicon oxide | Inorganic pigment | 8.7 |
| | n.a. | n.a. | Rheology additives | Balance |
| Protective layer | Poval, Kuraray Co. | Polyvinyl alcohol, | Binder | 79.0 |
| 1.0 g/m² | | highly saponified, high | | |
| | | viscosity | | |
| | | Zinc stearate | Lubricant/release | 4.0 |
| | | | agent | |
| | | Ammonium zirconium | Crosslinker | 15.0 |
| | | carbonate | | |
| | n.a. | n.a. | Rheology additives | Balance |

n.a.: Common materials known to those skilled in the art.

TABLE 6a
Composition of the individual layers of the heat-
sensitive recording material according to example 6.
Example 6

| | Formulation | Formulation | | Quantity |
|---|---|---|---|---|
| Layer | ingredient | ingredient | | [% by |
| basis weight | Trade name | Chemical name | Function | wt.] |
| Color layer | | Calcined kaolin | Inorganic pigment | 52.2 |
| 7.0 g/m² | | Precipitated calcium | Inorganic pigment | 16.9 |
| | | carbonate, calcite type | | |
| | Latex, Styron Co. | Styrene-butadiene | Binder | 12.6 |
| | | latex | | |
| | | Carbon black | Dye/Color pigment | 19.0 |
| | n.a. | n.a. | Rheology additives | Balance |
| Heat-sensitive | Ropaque OP-96, | Styrene-acrylate | Scattering particles, | 38.5 |
| layer | Dow Co. | copolymer | polymer particles | |
| 3.5 g/m² | | Polyamidoamine | Crosslinker | 0.9 |
| | | epichlorohydrin (PAE) | | |
| | Chukyo Co. | Stearic acid amide | Heat-sensitive | 51.0 |
| | | Wax | material | |
| | Poval, Kuraray Co. | Polyvinyl alcohol, | Binder | 8.3 |
| | | partially saponified, | | |
| | | high viscosity | | |
| | n.a. | n.a. | Rheology additives | Balance |
| Protective layer | Poval, Kuraray Co. | Polyvinyl alcohol, | Binder | 79.0 |
| 1.0 g/m² | | partially saponified, | | |
| | | high viscosity | | |
| | | Zinc stearate | Lubricant/release | 4.0 |
| | | | agent | |
| | | Polyamidoamine | Crosslinker | 15.0 |
| | | epichlorohydrin (PAE) | | |
| | n.a. | n.a. | Rheology additives | Balance |

n.a.: Common materials known to those skilled in the art.

In further embodiments 1* to 6*, the protective layers of examples 1 to 6 were each replaced by the following protective layer with a low content of inorganic pigment (less than 5% by weight):

TABLE 6b
Composition of an alternative protective layer

| | | | | |
|---|---|---|---|---|
| Protective layer | Poval, Kuraray Co. | Polyvinyl alcohol, | Binder | 78.0 |
| 1.5 g/m² | | partially saponified, | | |
| | | high viscosity | | |
| | | Silica | Inorganic pigment | 1.0 |
| | | Zinc stearate | Lubricant | 4.0 |
| | | Polyamidoamine | Crosslinker | 15.0 |
| | | epichlorohydrin (PAE) | | |
| | n.a. | n.a. | Rheology additives | Balance |

n.a.: Common materials known to those skilled in the art.

TABLE 7
Composition of the individual layers of the heat-sensitive
recording material according to Comparative example 7.
Comparative example 7

| | Formulation | Formulation | | Quantity |
|---|---|---|---|---|
| Layer | ingredient | ingredient | | [% by |
| basis weight | Trade name | Chemical name | Function | wt.] |
| Color layer | | Calcined kaolin | Inorganic pigment | 52.2 |
| 7.0 g/m² | | Precipitated calcium | Inorganic pigment | 16.9 |
| | | carbonate, calcite type | | |
| | Latex, Styron Co. | Styrene-butadiene | Binder | 12.6 |
| | | latex | | |
| | | Carbon black | Dye/Color pigment | 19.0 |
| | n.a. | n.a. | Rheology additives | Balance |
| Heat-sensitive | Ropaque OP-96, | Styrene-acrylate | Scattering particles, | 38.5 |
| layer | Dow Co. | copolymer | polymer particles | |
| 3.5 g/m² | | Polyamidoamine | Crosslinker | 0.9 |
| | | epichlorohydrin (PAE) | | |
| | Chukyo Co. | Stearic acid amide wax | Heat-sensitive material | 51.0 |
| | Poval, Kuraray Co. | Polyvinyl alcohol, | Binder | 8.3 |
| | | partially saponified, | | |
| | | high viscosity | | |
| | n.a. | n.a. | Rheology additives | Balance |
| Protective layer | Poval, Kuraray Co. | Polyvinyl alcohol, | Binder | 75.0 |
| 1.0 g/m² | | partially saponified, | | |
| | | high viscosity | | |
| | | Silicon oxide | Inorganic pigment | 8.0 |
| | | Zinc stearate | Lubricant/release | 4.0 |
| | | | agent | |
| | | Polyamidoamine | Crosslinker | 11.0 |
| | | epichlorohydrin (PAE) | | |
| | n.a. | n.a. | Rheology additives | Balance |

n.a.: Common materials known to those skilled in the art.

It has been shown that using any mixture of scattering particles/polymer particles (e.g., styrene-acrylate copolymer) and inorganic pigment (e.g., calcined kaolin) in the insulating/color layer offers particular advantages in terms of improved barcode readability of the heat-sensitive recording material due to a high degree of fixation of the heat-sensitive layer on the color layer.

The mixing ratio between scattering particles/polymer particles and inorganic pigment is preferably in the range from 8:1 to 1:8, particularly preferably in the range from 4:1 to 1:4, based on the quantities [% by wt.] in the oven-dry state (ods).

These embodiments are explained more detail, without limiting their scope, using the following examples (examples 8 to 13).

TABLE 8
Composition of the individual layers of the heat-
sensitive recording material according to example 8.
Example 8

| | Formulation | Formulation | | Quantity |
|---|---|---|---|---|
| Layer | ingredient | ingredient | | [% by |
| basis weight | Trade name | Chemical name | Function | wt.] |
| Insulating layer | Ropaque HP-1055, | Styrene-acrylate | Scattering particles, | 41.1 |
| 2.5-3.0 g/m² | Dow Co. | copolymer | polymer particles | |
| | | Calcined kaolin | Inorganic pigment | 12.3 |
| | | Precipitated calcium | Inorganic pigment | 25.6 |
| | | carbonate, calcite type | | |
| | Poval, Kuraray Co. | Polyvinyl alcohol, | Binder | 3.0 |
| | | highly saponified, low | | |
| | | viscosity | | |
| | | Ammonium zirconium | Crosslinker | 2.0 |
| | | carbonate | | |
| | Latex, Styron Co. | Styrene-butadiene | Binder | 15.5 |
| | | latex | | |
| | n.a. | n.a. | Rheology additives | Balance |
| Color layer | | Kaolin | Inorganic pigment | 61.2 |
| 3.5 g/m² | Poval, Kuraray Co. | Polyvinyl alcohol, | Binder | 20.0 |
| | | highly saponified, low | | |
| | | viscosity | | |
| | | Ammonium zirconium | Crosslinker | 6.2 |
| | | carbonate | | |
| | | Carbon black | Dye/color pigment | 12.0 |
| | n.a. | n.a. | Rheology additives | Balance |
| Heat-sensitive | Ropaque OP-96, | Styrene-acrylate | Polymer particles | 44.1 |
| layer | Dow Co. | copolymer | | |
| 3.5 g/m² | | Sodium metaborate | Crosslinker | 0.9 |
| | | tetrahydrate | | |
| | Chukyo Co. | Stearic acid amide wax | Heat-sensitive | 34.4 |
| | | | material | |
| | | Silicon oxide | Inorganic pigment | 8.0 |
| | | Zinc stearate | Lubricant/release | 3.9 |
| | | | agent | |
| | Poval, Kuraray Co. | Polyvinyl alcohol, | Binder | 8.3 |
| | | highly saponified, high | | |
| | | viscosity | | |
| | n.a. | n.a. | Rheology additives | Balance |
| Protective layer | Poval, Kuraray Co. | Polyvinyl alcohol, | Binder | 89.0 |
| 1.0 g/m² | | highly saponified, high | | |
| | | viscosity | | |
| | | Zinc stearate | Lubricant/release | 4.0 |
| | | | agent | |
| | | Sodium metaborate | Crosslinker | 5.0 |
| | | tetrahydrate | | |
| | n.a. | n.a. | Rheology additives | Balance |

n.a.: Common materials known to those skilled in the art.

TABLE 9
Composition of the individual layers of the heat-
sensitive recording material according to example 9.
Example 9

| | Formulation | Formulation | | Quantity |
|---|---|---|---|---|
| Layer | ingredient | ingredient | | [% by |
| basis weight | Trade name | Chemical name | Function | wt.] |
| Color layer | Ropaque HP-1055, | Styrene-acrylate | Scattering | 36.3 |
| 5.2 g/m² | Dow Co. | copolymer | particles/polymer | |
| | | | particles | |
| | | Calcined kaolin | Inorganic pigment | 16.0 |
| | Latex, Styron Co. | Styrene-butadiene | Binder | 25.7 |
| | | latex | | |
| | | Carbon black | Dye/color pigment | 21.2 |
| | n.a. | n.a. | Rheology additives | Balance |
| Heat-sensitive | Ropaque OP-96, | Styrene-acrylate | Scattering particles, | 35.1 |
| layer | Dow Co. | copolymer | polymer particles | |
| 3.5 g/m² | | Sodium metaborate | Crosslinker | 0.7 |
| | | tetrahydrate | | |
| | Chukyo Co. | Stearic acid amide wax | Heat-sensitive material | 40.4 |
| | | Silicon oxide | Inorganic pigment | 9.0 |
| | | Zinc stearate | Lubricant/release agent | 3.2 |
| | Poval, Kuraray Co. | Polyvinyl alcohol, | Binder | 8.3 |
| | | highly saponified, high | | |
| | | viscosity | | |
| | n.a. | n.a. | Rheology additives | Balance |
| Protective layer | Poval, Kuraray Co. | Polyvinyl alcohol, | Binder | 89.0 |
| 1.0 g/m² | | highly saponified, high | | |
| | | viscosity | | |
| | | Zinc stearate | Lubricant/release agent | 4.0 |
| | | Sodium metaborate | Crosslinker | 5.0 |
| | | tetrahydrate | | |
| | n.a. | n.a. | Rheology additives | Balance |

n.a.: Common materials known to those skilled in the art.

TABLE 10
Composition of the individual layers of the heat-
sensitive recording material according to example 10.
Example 10

| | Formulation | Formulation | | Quantity |
|---|---|---|---|---|
| Layer | ingredient | ingredient | | [% by |
| basis weight | Trade name | Chemical name | Function | wt.] |
| Color layer | Ropaque HP-1055, | Styrene-acrylate | Scattering | 32.2 |
| 7.5 g/m² | Dow Co. | copolymer | particles/polymer | |
| | | | particles | |
| | | Calcined kaolin | Inorganic pigment | 15.0 |
| | | Kaolin | Inorganic pigment | 16.2 |
| | Latex, Styron Co. | Styrene-butadiene | Binder | 12.8 |
| | | latex | | |
| | | Carbon black | Dye/color pigment | 23.3 |
| | n.a. | n.a. | Rheology additives | Balance |
| Heat-sensitive | Plastic Pigment | Styrene polymer | Scattering | 35.3 |
| layer | 756A, Trinseo LLC | | particles/polymer | |
| 4.0 g/m² | | | particles | |
| | Chukyo Co. | Stearic acid amide wax | Heat-sensitive material | 30.8 |
| | Latex, Styron Co. | Styrene-butadiene | Binder | 10.3 |
| | | latex | | |
| | | Zinc stearate | Lubricant/release agent | 3.5 |
| | | Precipitated calcium | Inorganic pigment | 6.0 |
| | | carbonate, calcite type | | |
| | | Silicon oxide | Inorganic pigment | 9.0 |
| | n.a. | n.a. | Rheology additives | Balance |
| Protective layer | Poval, Kuraray Co. | Polyvinyl alcohol, | Binder | 79.0 |
| 1.0 g/m² | | highly saponified, high | | |
| | | viscosity | | |
| | | Zinc stearate | Lubricant/release agent | 4.0 |
| | | Ammonium zirconium | Crosslinker | 15.0 |
| | | carbonate | | |
| | n.a. | n.a. | Rheology additives | Balance |

n.a.: Common materials known to those skilled in the art.

TABLE 11
Composition of the individual layers of the heat-
sensitive recording material according to example 11.
Example 11

| | Formulation | Formulation | | Quantity |
|---|---|---|---|---|
| Layer | ingredient | ingredient | | [% by |
| basis weight | Trade name | Chemical name | Function | wt.] |
| Color layer | Ropaque HP-1055, | Styrene-acrylate | Scattering | 17.2 |
| 7.0 g/m² | Dow Co. | copolymer | particles/polymer | |
| | | | particles | |
| | | Calcined kaolin | Inorganic pigment | 35.0 |
| | | Precipitated calcium | Inorganic pigment | 16.9 |
| | | carbonate, calcite type | | |
| | Latex, Styron Co. | Styrene-butadiene | Binder | 12.6 |
| | | latex | | |
| | | Carbon black | Dye/Color pigment | 19.0 |
| | n.a. | n.a. | Rheology additives | Balance |
| Heat-sensitive | Ropaque OP-96, | Styrene-acrylate | Scattering particles, | 38.5 |
| layer | Dow Co. | copolymer | polymer particles | |
| 3.5 g/m² | | Ammonium zirconium | Crosslinker | 0.9 |
| | | carbonate | | |
| | Chukyo Co. | Stearic acid amide wax | Heat-sensitive | 51.0 |
| | | | material | |
| | Poval, Kuraray Co. | Polyvinyl alcohol, | Binder | 8.3 |
| | | highly saponified, high | | |
| | | viscosity | | |
| | n.a. | n.a. | Rheology additives | Balance |
| Protective layer | Poval, Kuraray Co. | Polyvinyl alcohol, | Binder | 79.0 |
| 1.0 g/m² | | highly saponified, high | | |
| | | viscosity | | |
| | | Zinc stearate | Lubricant/release | 4.0 |
| | | | agent | |
| | | Ammonium zirconium | Crosslinker | 15.0 |
| | | carbonate | | |
| | n.a. | n.a. | Rheology additives | Balance |

n.a.: Common materials known to those skilled in the art.

TABLE 12
Composition of the individual layers of the heat-
sensitive recording material according to example 12.
Example 12

| | Formulation | Formulation | | Quantity |
|---|---|---|---|---|
| Layer | ingredient | ingredient | | [% by |
| basis weight | Trade name | Chemical name | Function | wt.] |
| Color layer | Ropaque HP-1055, | Styrene-acrylate | Scattering | 15.3 |
| 4.0 g/m² | Dow Co. | copolymer | particles/polymer | |
| | | | particles | |
| | | Calcined kaolin | Inorganic pigment | 14.7 |
| | | Precipitated calcium | Inorganic pigment | 28.3 |
| | | carbonate, calcite type | | |
| | Latex, Styron Co. | Styrene-butadiene | Binder | 8.9 |
| | | latex | | |
| | | Carbon black | Dye/color pigment | 32.4 |
| | n.a. | n.a. | Rheology additives | Balance |
| Heat-sensitive | Chukyo Co. | Stearic acid amide wax | Scattering | 72.3 |
| layer | | | particles/heat- | |
| 6.0 g/m² | | | sensitive | |
| | | | material/lubricant | |
| | Poval, Kuraray Co. | Polyvinyl alcohol, | Binder | 12.8 |
| | | highly saponified, high | | |
| | | viscosity | | |
| | | Precipitated calcium | Inorganic pigment | 5.5 |
| | | carbonate, calcite type | | |
| | | Silicon oxide | Inorganic pigment | 8.7 |
| | n.a. | n.a. | Rheology additives | Balance |
| Protective layer | Poval, Kuraray Co. | Polyvinyl alcohol, | Binder | 79.0 |
| 1.0 g/m² | | highly saponified, high | | |
| | | viscosity | | |
| | | Zinc stearate | Lubricant/release | 4.0 |
| | | | agent | |
| | | Ammonium zirconium | Crosslinker | 15.0 |
| | | carbonate | | |
| | n.a. | n.a. | Rheology additives | Balance |

n.a.: Common aids known to those skilled in the art.

TABLE 13a
Composition of the individual layers of the heat-
sensitive recording material according to example 13.
Example 13

| | Formulation | Formulation | | Quantity |
|---|---|---|---|---|
| Layer | ingredient | ingredient | | [% by |
| basis weight | Trade name | Chemical name | Function | wt. |
| Color layer | Ropaque HP-1055, | Styrene-acrylate | Scattering | 17.2 |
| 7.0 g/m² | Dow Co. | copolymer | particles/polymer | |
| | | | particles | |
| | | Calcined kaolin | Inorganic pigment | 35.0 |
| | | Precipitated calcium | Inorganic pigment | 16.9 |
| | | carbonate, calcite type | | |
| | Latex, Styron Co. | Styrene-butadiene | Binder | 12.6 |
| | | latex | | |
| | | Carbon black | Dye/Color pigment | 19.0 |
| | n.a. | n.a. | Rheology additives | Balance |
| Heat-sensitive | Ropaque OP-96, | Styrene-acrylate | Scattering particles, | 38.5 |
| layer | Dow Co. | copolymer | polymer particles | |
| 3.5 g/m² | | Polyamidoamine | Crosslinker | 0.9 |
| | | epichlorohydrin (PAE) | | |
| | Chukyo Co. | Stearic acid amide | Heat-sensitive | 51.0 |
| | | Wax | material | |
| | Poval, Kuraray Co. | Polyvinyl alcohol, | Binder | 8.3 |
| | | partially saponified, | | |
| | | high viscosity | | |
| | n.a. | n.a. | Rheology additives | Balance |
| Protective layer | Poval, Kuraray Co. | Polyvinyl alcohol, | Binder | 79.0 |
| 1.0 g/m² | | partially saponified, | | |
| | | high viscosity | | |
| | | Zinc stearate | Lubricant/release | 4.0 |
| | | | agent | |
| | | Polyamidoamine | Crosslinker | 15.0 |
| | | epichlorohydrin (PAE) | | |
| | n.a. | n.a. | Rheology additives | Balance |

n.a.: Common materials known to those skilled in the art.

In further embodiments 8* to 13*, the protective layers of examples 8 to 13 were each replaced by the following protective layer with a low content of inorganic pigment (less than 5% by weight):

TABLE 13b
Composition of an alternative protective layer

| | | | | |
|---|---|---|---|---|
| Protective layer | Poval, Kuraray Co. | Polyvinyl alcohol, | Binder | 78.0 |
| 1.5 g/m² | | partially saponified, | | |
| | | high viscosity | | |
| | | Silica | Inorganic pigment | 1.0 |
| | | Zinc stearate | Lubricant | 4.0 |
| | | Polyamidoamine | Crosslinker | 15.0 |
| | | epichlorohydrin (PAE) | | |
| | n.a. | n.a. | Rheology additives | Balance |

n.a.: Common materials known to those skilled in the art.

The above heat-sensitive recording materials were analyzed as described below.

### 1) Dynamic Color Density (Dynamic Sensitivity):

a) The heat-sensitive recording materials (6 cm wide strips) were thermally printed using a GeBE PrinterLab GPT-10000 test printer (GeBE Elektronik und Feinwerktechnik GmbH, Germany) with a Kyocera print bar of 305 dpi at an applied voltage of 24 V and a maximum pulse width of 0.8 ms with a checkerboard pattern with 10 energy gradations. The image density (optical density, OD) was measured with a SpectroEye densitometer from X-Rite at an energy level of 12.79 mJ/mm². Only the OD values at an energy level of 12.79 mJ/mm² were recorded, since the maximum optical density is reached at this energy level (=OD 1).

The measurement uncertainty of the OD values is estimated to be ≤2%.

b) The heat-sensitive recording materials (6 cm wide strips) were thermally printed using a GeBE PrinterLab GPT-10000 test printer (GeBE Elektronik und Feinwerktechnik GmbH, Germany) with a Kyocera print bar of 305 dpi at an applied voltage of 24 V and a maximum pulse width of 0.8 ms with a pulse width determined by preliminary tests (cf. a)) with a checkerboard pattern without energy gradations, wherein the pulse width is selected so that an optical density of 1.20+0.05 is achieved. The area of one square of the print pattern corresponds to 80×80 dots. The image densities of the printed and non-printed areas (optical density, OD) were measured with a SpectroEye densitometer from X-Rite, wherein the measurement uncertainty of the OD values is estimated to be ≤2%. The scatter of the % values calculated according to (Eq. 2) is ±2 percentage points.

### 2) Relative Print Contrast:

The relative contrast was calculated using the value of the optical density of a thermally printed area (ODs) or a mechanically treated area (friction sensitivity test) (ODs) and the optical density of a non-printed area (ODw) according to Eq. (1) (s=black area, w=white area):

$$\% rel . print contrast = ( \frac{ODs - ODw}{ODs} ) * 100 \qquad ( Eq . 1 )$$

### 3) Resistance Test of the Printed Image

a) Resistance of the printed image under the conditions of artificial aging:

One sample of thermal recording paper, which was dynamically recorded according to the method of (1a), was stored for 7 days under the following conditions: i) 50° C. (dry aging), ii) 40° C., 85% relative humidity (wet aging), iii) under artificial light from fluorescent tubes, illuminance 16000 lux (light aging). At the end of the test period, the image density was measured at a current energy of 12.79 mJ/mm² and related to the corresponding image density values before artificial aging according to the formula (Eq. 2).

$$\% remaining rel . print contrast = ( \frac{rel . print contrast after test}{rel . print contrast before test} ) * 100 \qquad ( Eq . 2 )$$

b) Resistance to plasticizers (Omni film):

A plasticizer-containing wrapping film (PVC film with 20 to 25% dioctyl adipate) was placed in contact with two strips of the heat-sensitive recording material printed according to the method in (1b), avoiding creases and entrapment of air, wound into a roll, and stored for 16 hours. One strip was stored at room temperature (20 to 22° C.), the second at 40° C. After removing the film, the image density (OD) of the printed and non-printed areas was measured and used to determine the relative print contrast according to formula (Eq. 2) in relation to the corresponding image density values before plasticizer exposure.

c) Resistance to pressure sensitive adhesives:

Two strips of the heat-sensitive recording material were printed using the method in (1b). Transparent Tesa self-adhesive tape (tesafilm® crystal clear, #57315) and a separate strip of Tesa packaging tape (#04204) were applied to each strip, avoiding creases and entrapment of air. After storage at room temperature (20-22° C.), the image density (OD), through the respective adhesive tape, of the printed and non-printed areas was measured after seven days and used to determine the relative print contrast according to formula (Eq. 2) in relation to the corresponding image density values of the samples with freshly applied tape.

d) Resistance to hydrophobic/hydrophilic agents:

A drop/fingertip of sunflower oil (Nestle-Thomy 100% pure sunflower oil), lard (LARU GmbH pig lard), hand cream (lanolin hand cream), sweat (produced according to DIN EN ISO 105-E04), milk (3.5% fat), ethanol (40% in water) and water (tap water) was applied each to a printed and a non-printed area on respective strips of the heat-sensitive recording material printed according to the method in (1b). After an exposure time of 30 minutes, the agents were removed by brief contact with a standard kitchen towel, and the papers were stored at room temperature (20-22° C.). After a specific storage period (see Table 9), the image density (OD) of the printed and non-printed areas was measured and used to determine the relative print contrast according to the formula (Eq. 2) in relation to the corresponding image density values before exposure to said agents.

The results of the evaluations of the heat-sensitive recording materials are summarized below.

TABLE 14
Paper whiteness, image density, rel.
print contrast and artificial aging

| | Paper | | Rel. print | | | |
|---|---|---|---|---|---|---|
| | whiteness | OD 1 (12.79 | contrast | Artificial aging* | | |
| Example | in % | mJ/mm²) | in % | dry | moist | light |
| Example 6 | 50.2 | 1.38 | 62 | 99 | 99 | 100 |
| (laboratory | | | | | | |
| test) | | | | | | |
| Example 6 | 43.0 | 1.52 | 59 | 100 | 100 | 100 |
| (Production) | (1) | | | | | |
| | 42.8 | 1.51 | 60 | | | |
| | (2) | | | | | |
| | 42.8 | 1.55 | 61 | | | |
| | (3) | | | | | |
| Comparative | 50.6 | 1.34 | 58 | 100 | 98 | 100 |
| example 7 | | | | | | |
| (laboratory | | | | | | |
| test) | | | | | | |
| Comparative | 42.8 | 1.41 | 55 | 100 | 100 | 98 |
| example 7 | | | | | | |
| (Technical | | | | | | |
| center) | | | | | | |

*Percentage of remaining print contrast according to Eq. 2

TABLE 15
Resistances

| | | Omni | | | | | | | | | |
|---|---|---|---|---|---|---|---|---|---|---|---|
| | Omni | film* | Tesa | Tesa, | Sunflower | | Hand | | | | Water |
| | film* | (16 h, | #57315* | #04204* | oil* | Lard* | cream* | Sweat* | Milk* | Ethanol* | resistance* |
| Example | (16 h, RT) | 40 ° C.) | (7 d, RT) | (7 d, RT) | (24 h, RT) | (24 h, RT) | (24 h, RT) | (3 h, RT) | (3 h, RT) | (3 h, RT | (3 h, RT) |
| Example 6 | 98 | 100 | 100 | 100 | 82 | 97 | 100 | 94 | 100 | 99 | 95 |
| (laboratory | | | | | | | | | | | |
| test) | | | | | | | | | | | |
| Example 6 | 98 | 95 | 100 | 100 | 75 | 72 | 100 | 100 | 98 | 97 | 95 |
| (Production) | (1) | | | | | | | | | | |
| | 98 | 97 | 100 | 98 | 73 | 77 | 98 | 97 | 95 | 95 | 94 |
| | (2) | | | | | | | | | | |
| | 98 | 98 | 100 | 100 | 75 | 100 | 97 | 100 | 98 | 95 | 94 |
| | (3) | | | | | | | | | | |
| Comparative | 100 | 100 | 100 | 100 | 75 | 83 | 100 | 97 | 94 | 94 | 92 |
| example 7 | | | | | | | | | | | |
| (laboratory | | | | | | | | | | | |
| test) | | | | | | | | | | | |
| Comparative | 100 | 100 | 100 | 100 | 58 | 96 | 96 | 98 | 100 | 100 | 95 |
| example 7 | | | | | | | | | | | |
| (Technical | | | | | | | | | | | |
| center) | | | | | | | | | | | |

*Percentage remaining print contrast according to Eq. 2

### Shelf Life of the Printed/Unprinted Heat-Sensitive Recording Materials According to the Invention:

A strip of the heat-sensitive recording material was printed on and measured according to the method of (1b) (OD, image density before storage) and, together with an unprinted strip of the heat-sensitive recording material, subjected to storage for four weeks between two glass plates at 60° C., a pressure of 1350 N/m², a relative humidity of 50% and in the absence of light.

After storage and air conditioning to room temperature, the unprinted strip was printed according to (1b) (=remaining write performance), the printed and unprinted areas were measured, and the relative print contrast was determined according to the formula (Eq. 2) in relation to the corresponding image density values of the printed strip before storage. The printed and non-printed areas of the printed strip are also measured (=remaining image stability) and used to determine the relative print contrast according to the formula (Eq. 2) in relation to the corresponding image density values before storage.

### Equipping the Heat-Sensitive Recording Materials as Self-Adhesive Labels.

Applying a layer of adhesive to the back of an A4 sheet.

a) The adhesive dispersion is applied with a blade to the back side of an A4 paper supporting the heat-sensitive layer on the front side (heat-sensitive recording material) and dried at max. 70° C. with a hot air dryer. To protect the adhesive layer during further processing, a siliconized release paper is laminated onto the adhesive layer while avoiding entrapment of air and creases.

b) If there is an “adhesive-liner sandwich”, consisting of a thin layer of adhesive between two release papers, the adhesive layer (sticky side) is laminated onto the back side of the A4 thermal paper after removing one of the two liner papers, while avoiding entrapment of air and creases.

In the production of the label, it is irrelevant whether the adhesive layer is applied first and then the heat-sensitive recording layer is applied to the opposite side supporting the adhesive layer.

In order to produce self-adhesive labels, a removable acrylate-based adhesive (R5000N, Avery Fasson) was used as a commercially available adhesive.

The heat-sensitive recording materials converted into self-adhesive labels were tested/evaluated as follows (Table 10).

### Adhesive Migration Test of Heat-Sensitive Labels

A strip of the heat-sensitive recording material was printed on and measured according to the method of (1b) (OD, image density before storage) and, together with an unprinted strip of the heat-sensitive recording material, subjected to storage for four weeks between two glass plates at 60° C., a pressure of 1350 N/m², a relative humidity of 50% and in the absence of light.

After storage and air conditioning to room temperature, the unprinted strip was printed according to (1b) (=remaining write performance), the printed and unprinted areas were measured, and the relative print contrast was determined according to the formula (Eq. 2) in relation to the corresponding image density values of the printed strip before storage. The printed and non-printed areas of the printed strip are also measured (=remaining image stability) and used to determine the relative print contrast according to the formula (Eq. 2) in relation to the corresponding image density values before storage.

TABLE 16
Shelf life (image stability/write performance) and adhesive
migration test (image stability/write performance)

| | Shelf life | | Adhesive migration test | |
|---|---|---|---|---|
| | | Write | | Write |
| | Image | perfor- | Image | perfor- |
| Example | stability* | mance* | stability* | mance* |
| Example 6 | 99 | 100 | 100 | 100 |
| (laboratory test) | | | | |
| Example 6 | 100 (1) | 100 | 100 | 100 |
| (Production) | 100 (2) | 100 | 100 | 100 |
| | 100 (3) | 100 | 100 | 100 |
| Comparative | 100 | 100 | 100 | 100 |
| example 7 | | | | |
| (laboratory test) | | | | |
| Comparative | 85 | 88 | 76 | 76 |
| example 7 | | | | |
| (Technical center) | | | | |

*Percentage of remaining print contrast according to Eq. 2

The smoothness measurement was carried out according to DIN 53107 (2016).

The thickness measurement was carried out according to DIN-EN ISO 534 (2011).

To test the deposition behavior of the heat-sensitive recording materials, a commercially available thermal printer (model: Zebra ZD420) was used. After a test run of 10 km, a visual inspection for depositions on the thermal print head was carried out. The assessment was based on the following grading system: Grade 0=no depositions, grade 1=slight depositions, grade 2=medium depositions, grade 3=severe depositions. Marketable heat-sensitive recording materials show no depositions (grade 0).

TABLE 17
Deposition, Bekk smoothness in sec. and thickness in μm

| | Support material | | | | | | | | |
|---|---|---|---|---|---|---|---|---|---|
| | with optional | | Color | | Heat-sensitive | | Protective | | |
| | starch precoat | | layer | | layer | | layer | | |
| | Smooth- | Thick- | Smooth- | Thick- | Smooth- | Thick- | Smooth- | Thick- | Deposit |
| | ness | ness | ness | ness | ness | ness | ness | ness | Grade |
| Example 6 | 53 | 71.0 | 155 | 76.0 | 302 | 81.0 | 1399 | 81.0 | 0 |
| (laboratory | | | | | | | | | |
| test) | | | | | | | | | |
| Example 6 | 83 | 69.0 | 190 | 73.5 | 363 | 81.5 | 1111 | 81.5 | 0 |
| (Production) | | | | | (1) | (1) | (1) | (1) | (1) |
| | | | | | 392 | 80.0 | 1425 | 80.0 | 0 |
| | | | | | (2) | (2) | (2) | (2) | (2) |
| | | | | | 378 | 80.0 | 1397 | 80.0 | 0 |
| | | | | | (2) | (3) | (3) | (3) | (3) |
| Comparative | 53 | 71.0 | 155 | 76.0 | 170 | 84.5 | 210 | 85.0 | 0 |
| example 7 | | | | | | | | | |
| (laboratory | | | | | | | | | |
| test) | | | | | | | | | |
| Comparative | 83 | 69.0 | 190 | 73.5 | 225 | 83.0 | 282 | 83.5 | 0 |
| example 7 | | | | | | | | | |
| (technical | | | | | | | | | |
| center) | | | | | | | | | |

Before determining the residual moisture (paper moisture), the heat-sensitive recording materials were stored for one week at room temperature and a relative humidity of 30%.

The residual moisture (paper moisture) was determined using a Precisa XM60 moisture analyzer using aluminum trays (70 mm) at room temperature and a relative humidity of 30%. “Standard” was selected as the heating rate, and the maximum temperature was set to 120° C. After taring the aluminum tray, it was loaded with a paper sample of 0.5 to 0.7 g of the corresponding paper sample. For this purpose, the sample was shaped and cut so that it could be placed in the aluminum tray without touching the heating element. In auto-start mode, the determination of the residual moisture started automatically after the sample chamber was closed, and the residual moisture value could be read off after completion.

TABLE 18
Residual moisture in %

| | | | | Support |
|---|---|---|---|---|
| | Support | | Support | material with |
| | material | Support | material with | color layer, |
| | with | material | color layer | heat-sensitive |
| | optional | with | and heat- | layer, and |
| | starch | color | sensitive | protective |
| | precoat | layer | layer | layer |
| | RM | RM | RM | RM |
| Example 6 | 4.6 | 4.5 | 6.5 | 8.2 |
| (laboratory test) | | | | |
| Example 6 | 4.8 | 5.1 | 7.1 | 9.5 |
| (Production) | | | | |
| Comparison | 4.6 | 4.5 | 6.5 | 8.2 |
| example 7 | | | | |
| (laboratory test) | | | | |
| Comparison | 5.1 | 5.3 | 7.3 | 10.1 |
| example 7 | | | | |
| (technical | | | | |
| center) | | | | |

TABLE 19
Water-wet abrasion resistance.

| | Turbidity |
|---|---|
| Example 6 | 7.7 |
| (laboratory test) | |
| Example 6 | 8.1 (1) |
| (Production) | 6.2 (2) |
| | 2.6 (3) |
| Comparative example 7 | 11.5 |
| (laboratory test) | |
| Comparative example 7 | 11.7 |
| (Technical center) | |

The water-wet abrasion resistance of the heat-sensitive recording materials was evaluated using a wet-rub tester (type NSE-1IR) from the Adams Co. and a photometer (DR3900) from the Hach-Lange Co. An unprinted strip (210×24 mm) of the heat-sensitive recording material was provided with double-sided adhesive tape on the back and stuck onto the guide roller of the wet-rub tester. 30 ml of distilled water were added into the so-called sample tray before the wet-rub tester was switched on. The guide roller was lowered onto the drive roller. After 50 s, the guide roller was lifted from the drive roller. The drive roller was rinsed with 10 ml of distilled Water. The rinsing water was collected in the sample tray. Subsequently, the turbidity of the water was determined as absorbance by means of the photometer. The following evaluation scale was used to assess wet abrasion resistance based on the extinction values: <5 corresponds to very good, 5-10 corresponds to good, and 10-20 corresponds to satisfactory.

1. A heat-sensitive recording material comprising
a support material in sheet form,
a color layer on one side of the support material in sheet form, and
a heat-sensitive layer on the color layer such that the color layer is at least partially covered,
wherein the heat-sensitive layer is designed to become translucent when localized heat is applied such that the underlying color layer becomes visible,
a protective layer on the heat-sensitive layer, characterized in that the protective layer contains less than 5% by weight of pigments.

2. A heat-sensitive recording material according to claim 1, characterized in that the color layer comprises at least one pigment and/or a dye.

3. The heat-sensitive recording material according to claim 1, characterized in that the heat-sensitive layer comprises at least one scattering particle having a glass transition temperature of −55° C. to 130° C., a melting temperature of less than 250° C., and/or an average particle size in the range from 0.1 to 2.5 μm.

4. The heat-sensitive recording material according to claim 1, characterized in that the heat-sensitive layer comprises at least one heat-sensitive material having a melting temperature in the range from 40 to 200° C. and/or a glass transition temperature in the range from 40 to 200° C.

5. The heat-sensitive recording material according to claim 1, characterized in that an insulating layer is present between the support material in sheet form and the color layer, wherein the insulating layer has a Bekk smoothness of more than 50 s.

6. The heat-sensitive recording material according to claim 1 in that the color layer is both a color layer and an insulating layer, wherein the color layer, which is also an insulating layer, preferably has a Bekk smoothness of more than 50 s, preferably more than 100 s.

7. The heat-sensitive recording material according to claim 5, characterized in that the insulating layer or the color layer, which is both a color layer and an insulating layer, comprises at least one heat-insulating material comprising a styrene-acrylate copolymer.

8. The heat-sensitive recording material according to claim 5, characterized in that the insulating layer or the color layer, which is both a color layer and an insulating layer, comprises a mixture of scattering particles, in comprising a styrene/acrylate copolymer, and at least one inorganic pigment.

9. The heat-sensitive recording material according to claim 1, characterized in that a layer comprising starch is present directly on at least one side of the support material in sheet form wherein the layer comprising starch has a Bekk smoothness of more than 20 s.

10. The heat-sensitive recording material according to claim 1, characterized in that the protective layer has a Bekk smoothness of at least 350 s, the Bekk smoothness being determined according to DIN 53107 (2016).

11. The heat-sensitive recording material according to claim 1, characterized in that the heat-sensitive recording material has a dynamic color density of at least 1.35 optical density units according to the method for determining the dynamic color density defined in the description.

12. The heat-sensitive recording material according to claim 1, characterized in that the protective layer comprises at least one of the following components selected from
polyvinyl alcohol binder,
a lubricant/release agent, based on waxes or fats, fatty acids or salts of fatty acids, or silicones
a crosslinking agent, and/or
a rheology additive.

13. The heat-sensitive recording material according to claim 1, characterized in that the protective layer has a basis weight in the range of 0.01 and 3.5 g/m².

14. The heat-sensitive recording material according to claim 1, characterized in that an adhesive layer is present on the support material in sheet form on the side on which the color layer is not located.

15. The heat-sensitive recording material according to claim 14, characterized in that the adhesive layer comprises at least one pressure-sensitive adhesive.

16. The heat-sensitive recording material according to claim 1, characterized in that the protective layer has a non-stick effect towards pressure-sensitive adhesives.

17. The heat-sensitive recording material according to claim 1, characterized in that a siliconized release layer is present on the protective layer, wherein the siliconized release layer preferably-has a Bekk smoothness of more than 400 s.

18. The heat-sensitive recording material according to claim 17, characterized in that the siliconized release layer comprises at least one siloxane.

19. The heat-sensitive recording material according to claim 1, characterized in that the heat-sensitive recording material has a residual moisture content of 2 to 14%.

20. The heat-sensitive recording material according to claim 1, characterized in that the heat-sensitive recording material has a surface whiteness of 35 to 60%.

21. The heat-sensitive recording material according to any one claim 1, characterized in that the contrast between locations where the heat-sensitive layer has become translucent due to application of localized heat and locations where the heat-sensitive layer has not become translucent due to application of localized heat is 40 to 80%.

22. The heat-sensitive recording material according to claim 1, characterized in that the protective layer contains no pigments except for unavoidable traces.

23. A receipt roll, adhesive label (roll), ticket (roll) or as printer paper for mechanical printers or pens and being comprised of the heat-sensitive recording material of claim 1.

24. The heat-sensitive recording material according to claim 2, characterized in that:
the color layer comprises a binder;
the heat-sensitive layer comprises at least one polymer particle having a glass transition temperature of −55° C. to 130° C., a melting temperature of less than 250° C., and/or an average particle size in the range from 0.1 to 2.5 μm;
the heat-sensitive layer comprises a fatty acid and/or a fatty acid amide;
an insulating layer is present between the support material in sheet form and the color layer, wherein the insulating layer has a Bekk smoothness of more than 100 s;
the insulating layer or the color layer, which is both a color layer and an insulating layer, comprises at least one calcined kaolin and hollow sphere pigments comprising a styrene-acrylate copolymer having a glass transition temperature of 40° C. to 80° C., and/or an average particle size of 0.1 to 2.5 μm;
a layer comprising starch is present directly on both sides of the support material in sheet form, wherein the layer comprising starch has a Bekk smoothness of more than 50 s, the Bekk smoothness being determined according to DIN 53107 (2016);
the protective layer has a Bekk smoothness of at least 1000 s, the Bekk smoothness being determined according to DIN 53107 (2016);
the protective layer comprises at least one of the following components:
a polyvinyl alcohol binder with a degree of saponification of more than 88%,
a lubricant/release agent,
a boron-free crosslinking agent, and/or
rheology additive;
the protective layer has a basis weight in the range of 0.1 and 1.5 g/m²; and
a siliconized release layer is present on the protective layer, wherein the siliconized release layer has a Bekk smoothness of more than 800 s, the Bekk smoothness being determined according to DIN 53107 (2016).
